(19) United States
(12) Patent Application Publication
(10) Pub. No.: US 2023/0042431 A1
(43) Pub. Date: Feb. 9, 2023

(54) PREDICTION AND PLANNING FOR MOBILE ROBOTS

(71) Applicant: Five AI Limited, Bristol (GB)

(72) Inventors: Subramanian RAMAMOORTHY, Bristol (GB); Mihai DOBRE, Bristol (GB); Roberto ANTOLIN, Bristol (GB); Stefano ALBRECHT, Bristol (GB); Simon LYONS, Bristol (GB); Svetlin Valentinov PENKOV, Bristol (GB); Morris ANTONELLO, Bristol (GB); Francisco EIRAS, Bristol (GB)

(73) Assignee: Five AI Limited, Bristol (GB)

(21) Appl. No.: 17/769,266

(22) PCT Filed: Apr. 22, 2020
(86) PCT No.: PCT/EP2020/061232

§ 371 Date: Apr. 14, 2022

(30) Foreign Application Priority Data
Oct. 16, 2019 (EP) PCT/EP2019/078062
Oct. 16, 2019 (EP) PCT/EP2019/078072
Jan. 30, 2020 (GB) 2001308.2

(51) Int. Cl. B60W 60/00; G06F 17/18

(52) U.S. Cl. CPC B60W 60/0011; G06F 17/18; B60W 2554/4044; B60W 2554/4046

(57) ABSTRACT

Ego actions for a mobile robot in the presence of at least one agent are autonomously planned. In a sampling phase, a goal for an agent is sampled from a set of available goals based on a probabilistic goal distribution, as determined using an observed trajectory of the agent. An agent trajectory is sampled, from a set of possible trajectories associated with the sampled goal, based on a probabilistic trajectory distribution, each trajectory of the set of possible trajectories reaching a location of the associated goal. In a simulation phase, an ego action is selected from a set of available ego actions and based on the selected ego action, the sampled agent trajectory, and a current state of the mobile robot, (i) behaviour of the mobile robot, and (ii) simultaneous behaviour of the agent are simulated, in order to assess the viability of the selected ego action.

### TECHNICAL FIELD

The present disclosure pertains to planning and prediction for autonomous vehicles and other mobile robots.

### BACKGROUND

A rapidly emerging technology is autonomous vehicles (AVs) that can navigate by themselves on urban roads. Such vehicles must not only perform complex maneuvers among people and other vehicles, but they must often do so while guaranteeing stringent constraints on the probability of adverse events occurring, such as collision with these other agents in the environments. An autonomous vehicle, also known as a self-driving vehicle, refers to a vehicle which has a sensor system for monitoring its external environment and a control system that is capable of making and implementing driving decisions automatically using those sensors. This includes in particular the ability to automatically adapt the vehicle's speed and direction of travel based on perception inputs from the sensor system. A fully-autonomous or “driverless” vehicle has sufficient decision-making capability to operate without any input from a human driver. However, the term autonomous vehicle as used herein also applies to semi-autonomous vehicles, which have more limited autonomous decision-making capability and therefore still require a degree of oversight from a human driver. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

### SUMMARY

A core problem addressed herein is that of predicting the behaviour of agent(s) so that actions that might be taken by a mobile robot (ego actions) can be evaluated. This allows ego actions to be planned in a way that takes into account predictions about other vehicles. A key benefit of the solution taught herein is explainability. The ability to explain and justify decisions taken by an autonomous system, particularly when those decisions may be safety critical (e.g. as in autonomous driving), is becoming increasingly important. In the context of autonomous vehicles and other mobile robots, increasing the transparency of autonomous decisions making ultimately means that such systems can be configured, tested and debugged more robustly, and will ultimately operate more reliably and predictably as a result. The present invention uses probabilistic predictions to accommodate uncertainty in the predictions in a way that maintains explainability.

A first aspect of the present invention provides a computer-implemented method of autonomously planning ego actions for a mobile robot in the presence of at least one agent (actor), the method comprising:
receiving an observed trajectory of the agent;
in a sampling phase:
sampling a goal for the agent from a set of available goals based on a probabilistic goal distribution, the observed trajectory used to determine the probabilistic goal distribution; and
sampling an agent trajectory, from a set of possible trajectories associated with the sampled goal, based on a probabilistic trajectory distribution, each trajectory of the set of possible trajectories reaching a location of the associated goal; and
in a simulation phase:
selecting for the mobile robot an ego action from a set of available ego actions, and
based on the selected ego action, the sampled agent trajectory, and a current state of the mobile robot, simulating (i) behaviour of the mobile robot, and (ii) simultaneous behaviour of the agent, in order to assess the viability of the selected ego action given the current mobile robot state.

In embodiments, the goal distribution may be computed, in a goal recognition phase, by determining, for each goal, a reward difference between (a) a first substantially optimal trajectory from an initial state of the observed trajectory to the location of the goal, and (b) a best-available trajectory that combines (b.i) the observed trajectory from the initial state to a current state of the observed trajectory with (b.ii) a second substantially optimal trajectory from the current state to the location of the goal, wherein the trajectory distribution is determined by determining a reward of each trajectory of the set of possible trajectories. That is, the best-available trajectory is constrained to match the observed trajectory up to the current state.

The first substantially optimal trajectory from the initial state to the location of the goal may be computed independently of the current state, or at least may not be constrained to match the observed trajectory up to the current state.

The reward of each trajectory and the reward difference of each goal may be determined using a reward function that rewards reduced travel time whilst penalizing unsafe trajectories. The reward function may also penalize other reward factor(s) such as lack of comfort (e.g. one or more of longitudinal jerk, latitudinal jerk, and path curvature).

The sampling phase and (where applicable) the goal recognition phase may be “open loop”, in the sense that the agent trajectories do not attempt to model reactive behaviour of the agent (i.e. they do not explicitly model any reaction of the agent to actions taken by the mobile robot and/or any other agent).

However, that does not mean that the simulation phase is restricted to open loop simulations. In the simulation phase, the sampled agent trajectory may be used to simulate the behaviour of the agent in an open loop or closed loop manner. With a closed-loop simulation, a simulated closed-loop agent trajectory may be determined based on the sampled agent trajectory (which may be open loop) and a set of simulated agent observations and/or simulated sensor feedback. The simulated observations/feedback may cause the simulated closed-loop agent trajectory to deviate from the sampled agent trajectory in a reactive manner. For example, the closed-loop trajectory could simulate the effect of adaptive cruise control and/or proportional control (without having to necessarily model those effects in the trajectory sampling/goal recognition phases).

Each trajectory may take the form of a sequence of states. A state may encode location information at a particular time instance but may also encode motion information such as one or more of (instantaneous) speed, heading, acceleration (magnitude and/or direction), jerk (first time derivative of acceleration) etc. More generally, a trajectory may encode spatial information (path component) but also motion information (motion component).

With closed-loop simulation, the motion component can be seen as a target, from which the actual simulated motion of the agent is permitted to deviate in a reactive manner.

The first and second trajectories may be determined in a first search process, which seeks to optimize a reward or estimated cost of the first and second trajectories. In the described examples, an estimated cost is used in the trajectory search process, and the estimated cost considers travel time to the goal location only and ignores any other cost factor(s) (though any such other factor(s) may still be accounted for in determining the cost difference, and the rewards of individual trajectories).

As will be appreciated, the terminology “minimizing a cost” and “maximizing a reward” are completely synonymous. The described embodiments refer to maximizing a reward, defined by a reward function, which is completely equivalent to minimizing a cost, defined via a cost function. The choice of terminology does not imply any particular numerical representation of the cost/reward—a lower cost/higher reward could be represented by lower or higher numerical values.

The set of possible trajectories may be determined in a second search process, which is free to explore additional trajectories. This may include trajectories that do not reach the location of the goal but, in that event, trajectories found in the second tree search process are only added to the set of possible trajectories if they do reach the location of the associated goal.

The first and/or second search process may be performed over a search space of possible agent actions, wherein each trajectory corresponds to a searched agent action or a searched sequence of agent actions within the search space.

The sampling phase may comprise sampling a current agent action from a set of possible current agent actions based on a probabilistic current action distribution determined for the agent.

The probabilistic goal distribution may be determined using the observed trajectory and the sampled current agent action.

The probabilistic goal distribution may comprise a conditional probability of each goal given the observed trajectory and the sampled current agent maneuver.

The current action distribution may be determined by a probabilistic maneuver detector based on one or more observations of the agent, such as one or more states of the observed trajectory.

The first and/or second search process may be based on the sampled current agent action.

The simulation phase may comprise determining a predicted state of the mobile robot after the selected ego action has been completed.

Multiple iterations of the simulation phase may be performed, with an initial iteration being performed for the current mobile robot state (as above) and each subsequent iteration performed for the predicted mobile robot state determined in the previous iteration, until a terminating condition is satisfied (e.g. the simulated behaviours are determined to violate a collision avoidance condition, or the mobile robot is determined to reach a desired mobile robot location; in some embodiments, an additional terminating condition may be a limit on the number of iterations that can be performed). In that case, each subsequent iteration would involve selecting a further ego action for the mobile robot and simulating its behaviour based on the further ego action and the predicted mobile robot state of the previous iteration, in order to assess the viability of the further ego action given that predicted ego state—with the consequence that a time sequence of multiple selected ego actions is assessed over the multiple iterations, for mobile robot states predicted further and further into the future.

The ego action may be selected probabilistically in (each iteration of) the simulation phase, e.g. using a probabilistic exploration technique.

The trajectory sampling phase and the multiple iterations of the simulation phase constitute a single “rollout”.

The method may comprise performing multiple rollouts, and in each rollout the sampling phase may be repeated to sample an agent goal, a corresponding agent trajectory and (where applicable) a current agent action to be considered in that rollout. Over a number of rollouts, this will generally result in different agent goals, trajectories and (where applicable) current actions being considered in different rollouts due to the probabilistic nature of the sampling.

In each rollout, one or multiple iterations of the simulation phase may be performed, depending on how many iterations are needed to reach a terminating condition.

That is, in each rollout, a single agent trajectory may be sampled, and used as basis for all iterations(s) of the simulation phase of that rollout.

The multiple rollouts may be performed according to a probabilistic tree search algorithm, such as Monte-Carlo tree Search (MCTS), in which a root node of a search tree represents the current state of the mobile robot, edges of the tree represent selected ego actions, and additional nodes represent predicted states. A branch of the tree may be explored in each rollout via the successive selection of ego action(s) in the iteration(s) of the simulation phase.

Each action may take the form of a basic maneuver or it may be a macro action formed of a sequence of multiple basic maneuvers.

Further aspects herein provide a computer program comprising one or more computers programmed or otherwise configured to carry out any method disclosed herein, and a computer program configured to program a computer system so as to carry out any such method.

Reference is made to International Patent Application Nos. PCT/EP2019/078062 and PCT/EP2019/078072 (the Earlier Applications), each of which is incorporated herein by reference in its entirety.

PCT/EP2019/078062 discloses, among other things, a form of prediction based on “inverse planning”. Inverse planning refers to a class of prediction methods which assume an agent will plan its decisions in a predictable manner. Inverse planning can be performed over possible maneuvers or behaviours in order to infer a current maneuver/behaviour of an agent based on relevant observations (a form of maneuver detection). Inverse planning can also be performed over possible goals, to infer a possible goal of an agent (a form of goal recognition). Goal recognition and maneuver detection will typically operate on different time scales. Goal recognition generally considers longer time periods into the future than maneuver detection. PCT/EP2019/078072 discloses, among other things, a planning framework for mobile robots based on Monte-Carlo Tree Search (MCTS). This provides a structured framework for reasoning about the possible effect of decisions taken by a mobile robot planner. Embodiments thereof incorporate predictions from inverse planning, in order to simulate (“roll out”) predicted behaviour of external agent(s) within the MCTS planning framework.

Embodiments are described below which incorporate goal recognition within a probabilistic planning framework. In particular, the described embodiments consider a form of inverse planning goal recognition within an MCTS framework. To some extent, these expand on the teaching of the Earlier Applications.

In the above, references are made to a cost of a trajectory and an estimated cost in the context of a search process. In the following description, the former is described in terms of “reward” (rather than cost) and the term “cost” (rather than estimated cost) is used in the context of a search process.

### BRIEF DESCRIPTION OF FIGURES

For a better understanding of the present invention, and to show how embodiments of the same may be carried into effect, reference is made to the following figures, in which:

FIG. 1 shows an example driving scenario with an ego vehicle and multiple agents in the vicinity of the ego vehicle;

FIG. 2 shows a schematic block diagram of a prediction and planning system;

FIG. 3 shows average driving time required to complete four representative scenario instances in simulation-based testing;

FIG. 4 shows a graph of results demonstrating the system's ability to predict the goal for a given agent as a scenario develops over time; goal are predicted probabilistically and the graph shows the probability given to the correct goal, which is seen to increase over time in each scenario instance;

FIGS. 5 to 8 schematically illustrate the four scenario instances respectively;

FIG. 9 shows a schematic function block diagram of an AV runtime stack;

FIG. 10 shows a flowchart for an example inverse planning method applied to probabilistic goal recognition;

FIG. 11 shows a schematic function block diagram for a maneuver planning method which incorporates goal predictions from inverse planning; and

FIG. 12 shows an example of a search tree search tree constructed by an MCTS maneuver planner.

### DETAILED DESCRIPTION

### I. Overview

The described embodiments of the invention provide an integrated prediction and planning system for an autonomous vehicle.

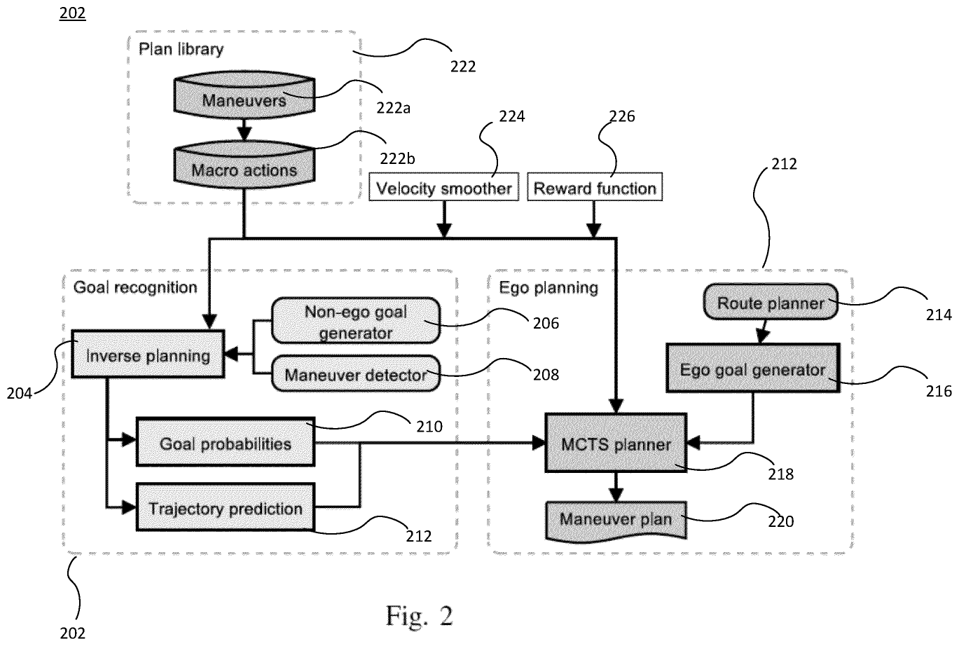

FIG. 2 shows a schematic block diagram of the system 200, which in turn is shown to comprise a goal recognition module 202 and an ego planning module 212. The system is able to evaluate and plan actions for a mobile robot (ego actions), such as an autonomous vehicle (ego vehicle—abbreviated as EV or AV), in the presence of one or more agents (e.g. other drivers, cyclists, pedestrians etc.), using a probabilistic behaviour prediction framework.

The goal recognition module 202 is shown to comprise the following (sub-)modules: an inverse planning module 204, an agent (non-ego) goal generator 206 and a maneuver detector 208. The maneuver detector 208 plans maneuvers using a Monte Carlo Tree Search (MCTC) algorithm as described later.

The ego planning module 212 is shown to comprise the following (sub-)modules: a route planner 214, an ego goal generator 216 and a maneuver planner 218. The maneuver planner 218 may be referred to as a planner for simplicity. Unless otherwise indicated, references to the planner below refer to the maneuver planner 218.

The agent goal generator 206 determines, for each of one or more agents in a driving scenario, a set of one or more available goals. Available goals are determined based on contextual information, such as road layout etc. The ego goal generator 216 operates in the same way but to determine one or more goals available to the ego vehicle. Goals to be executed by the AV are selected by the route planner 214.

The maneuver planner 218 plans optimal maneuvers to be taken by the AV, in order to reach the location of a selected goal. The maneuver planner 218 computes a maneuver plan 220 using goal probabilities 210 and associated agent trajectory predictions 212 provided by the inverse planner 204. The inverse planner 204 is a predictive component that predicts agent behaviour on the assumption that agents also plan rationally in order to reach their own desired goals.

Maneuvers are one form of action considered herein. As described in further detail below, the following examples consider basic maneuvers and “macro actions” which are predefined sequences of maneuvers. However, the description applies more generally to other forms of action that may be taken by a mobile robot and planned accordingly.

The goal recognition module 202 and the ego planning module 214 use a common library of maneuvers and “macro actions” (predefined maneuver sequences), and both leverage a velocity smoothing function 224 for smoothing computed trajectories and a reward function 226 for evaluating trajectories in relation to particular goals using a metric-based approach, in which certain factors (such as progression towards a desired goal) are rewarded and others (such as lack of safety, comfort etc.) are penalized. The likelihood of particular trajectories in respect of a given goal is estimated on the assumption that agents have the intention to execute optimal trajectories with respect to these metrics (i.e. that maximize the reward).

The ability to predict the intentions and driving trajectories of other vehicles is a key problem for autonomous driving. This problem is significantly complicated by the requirement to make fast and accurate predictions based on limited observation data which originate from a dynamically evolving environment with coupled multi-agent interactions.

One approach to make prediction tractable in such conditions is to assume that agents use one of a finite number of distinct behaviours. The behaviours typically represent high-level maneuvers such as lane-follow, lane-change, turn, stop, etc. A classifier of some type would be used to detect a vehicle's current executed maneuver based on its observed driving trajectory, which is then used to predict future trajectories to inform the planning of the ego vehicle under control. The limitation in such methods is that they only detect the current maneuver of other vehicles, hence planners using such predictions are essentially limited to the timescales of the detected maneuvers.

An alternative approach is to specify a finite set of possible goals for each other vehicle (such as the various road exit points) and to plan a full trajectory to each goal from the vehicle's observed local state. While this approach can generate longer-term predictions, it is limited by the fact that the generated trajectories must be relatively closely followed by a vehicle to yield high-confidence predictions.

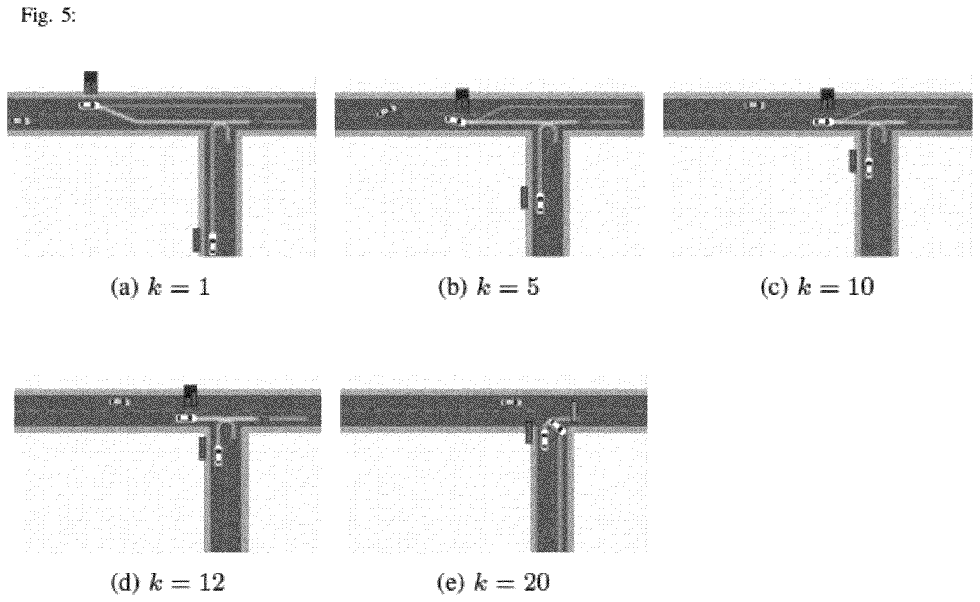

Recent methods based on deep learning have shown promising results for trajectory prediction in autonomous driving. Prediction models are trained on large datasets that are becoming available through data gathering campaigns involving sensorised vehicles traversing city roads. The resulting sensor information (typically various forms of visual and LIDAR feeds, sometimes including also RADAR) are used to produce forecasts through models ranging from video prediction to more contextualised forecasts taking into account environmental cues specifically. Reliable prediction over several second horizons remains a hard problem, in part due to the difficulties in capturing the coupled evolution of traffic. Much remains to be done towards addressing scenarios such as the ones illustrated in FIGS. 5 to 8. Another important limitation in some of these methods is the difficulty of incorporating hard constraints in an optimisation objective which must be differentiable (e.g. to avoid nonsensical predictions for a given situation). Finally, one of the most significant limitations of this class of methods is the difficulty in extracting interpretable predictions in a form that is amenable to efficient integration with planning methods that effectively represent multi-dimensional and hierarchical task objectives.

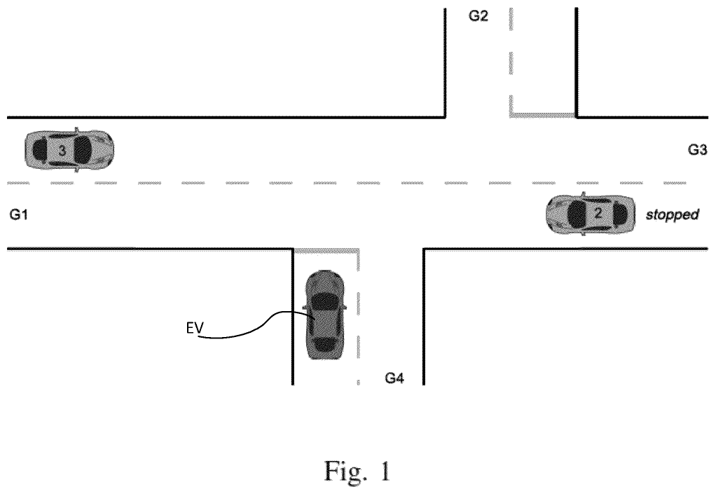

To address the above issues, a principle underlying the system 200 described herein is that, in order to predict the future maneuvers of a vehicle, some reasoning is needed about why—that is, to what end—the vehicle performed its current and past maneuvers, which will yield clues as to its intended goal. Knowledge of the goals of other vehicles enables prediction of their future maneuvers and trajectories in relation to their goals. Such long-term predictions facilitate planning over extended timescales to realise opportunities which might not otherwise present themselves, as illustrated in example in FIG. 1. To the extent that the predictions are structured around the interpretation of observed trajectories in terms of high-level maneuvers, the goal recognition process lends itself to intuitive interpretation for the purposes of debugging, at a level of detail suggested in FIG. 1.

FIG. 1 shows a junction scenario with four possible goals. An ego vehicle, labelled EV, has the goal of reaching location G1. Car 3 is driving east at constant speed. Car 2 slowed down until reaching its shown stopping location. The EV may infer that Car 2 is stopping because it intends to reach G2 but must wait until Car 3 has passed, then turn toward G2. This provides an opportunity for the ego vehicle to turn onto the road while Car 2 is waiting.

Ultimately, as the world develops towards making autonomous systems more trustworthy, these notions of interpretation and the ability to justify (explain) the system's decisions is increasingly key. In the present context, this applies to goal-based predictions and how these predictions influence autonomous driving decisions.

To this end, the integrated planning and prediction system 200 leverages the computational advantages of using a finite space of maneuvers (which is expressive enough for the purposes of interpreting observed behaviours), but extends the approach to planning and prediction of sequences (i.e., plans) of maneuvers. This is achieved via a novel integration of rational inverse planning to recognise the goals of other vehicles, with Monte Carlo Tree Search (MCTS) [6] to plan optimal maneuvers for the ego vehicle. Inverse planning and MCTS utilise a shared set of defined maneuvers to construct plans which are explainable by means of rationality principles, i.e. that plans are optimal with respect to given metrics. Rather than matching plans directly, the system 200 instead evaluates the extent to which an observed trajectory is rational for a given goal, providing robustness with respect to variability in trajectories. The described MCTS algorithm performs closed-loop forward-simulations of vehicle dynamics and their coupled interactions, but by separating control from maneuvers the system 200 is able to optimise the velocity profile across maneuvers and can leverage simplified open-loop control to increase efficiency of inverse planning.

The system 200 has been evaluated in simulations of four urban driving scenarios, including the scenario in FIG. 1, roundabout entry, and dense lane merging, showing that the system 200 robustly recognises the goals of other vehicles and generates near-optimal plans under diverse scenario initialisation. It is possible to extract intuitive explanations for the recognised goals and maneuver predictions in each scenario which justify the system's decisions. Further details of this evaluation are set out in Annex A below.

### II. Preliminaries and Problem Definition

Let [symbol] be the set of vehicles interacting with the ego vehicle in a local neighbourhood (including the ego vehicle). At time t, each vehicle i∈ [symbol] is in a local state sₜⁱ∈ [symbol] ⁱ, receives a local observation oⁱ∈ [symbol] ⁱ and can choose an action aⁱ∈ [symbol] ⁱ. The joint state (of the ego vehicle and the agent(s)) is denoted as sₜ∈ [symbol] =xᵢ [symbol] ⁱ. The notation s_{a:b} is used to denote the tuple (sₐ, . . . , s_{b}), and similarly for oₜ∈ [symbol] , aₜ∈ [symbol] . Observations depend on the joint state via p(oⁱ|sₜ), and actions depend on the observations via p(aₜⁱ|o_{1:t}ⁱ). In the system 200, a local state contains a vehicle's pose, velocity, and acceleration (herein, velocity and speed are used interchangeably); an observation contains the poses and velocities of nearby vehicles; and an action controls the vehicle's steering and acceleration.

The probability of a sequence of joint states s_{1:n}, n≥1, is given by

P(s_{1:n}=Πₜ₌₁ⁿ⁻¹ [symbol] p(oₜ|sₜ)p(aₜ|o_{1:t})p(sₜ₊₁|sₜ,aₜ)doₜdaₜ (1)

where p(sₜ₊₁|sₜ, aₜ) defines the joint vehicle dynamics, and independent local observations and actions are assumed:

p(oₜ|sₜ)=Πᵢp(oₜⁱ|sₜ) and p(aₜ|o_{1:t})=Πᵢp(aₜⁱ|o_{1:t}ⁱ).

Vehicles react to other vehicles via their local observations o_{1:n}ⁱ.

A planning problem is defined as finding an optimal “policy” π* which selects actions for an ego vehicle, ε, to achieve a specified goal, g^{ε}, while optimising a driving trajectory via a defined reward function.

A policy is a function π:( [symbol] ) [symbol] [symbol] ^{ε} which maps an observation sequence o_{1:n}^{ε} (observed trajectory) to an action aₜ^{ε}. A goal can be any (partial) state description g^{ε}⊂ [symbol] ^{ε}, though, by way of example, the following description focuses on-goals that specify target locations. Formally, define

Ωₙ={s_{1:n}|sₙ^{ε}⊆g^{ε}∧ [symbol] m<n:sₘ^{ε}⊆g^{ε}} (2)

where sₙ^{ε}⊆g\hat{ }ε means that sₙ^{ε} satisfies g^{ε}. The second condition in (2) ensures that Σₙ₌₁^{∞}∫_{Ω}_{ₙ} p(s_{1:n})ds_{1:n}≤1 for any policy π, which ensures soundness of the sum in (3). The problem is to find π* such that

$${π}^{*} ∈ {arg max}_{π} {\sum }_{n = 1}^{∞} {\int }_{{Ω}_{n}} p ( {s}_{1} : n ) {R}^{ε} ( {s}_{1 : n} ) d {s}_{1 : n} \qquad ( 3 )$$

Where Rⁱ(s_{1:n}) is the reward of s_{1:n} for vehicle i (See Section III-E, below). Intuitively, maximizing (3) entails optimising the probability of achieving the goal and the rewards of the generated trajectories. In the described implementation, (3) is approximated using a finite planning horizon (detailed in Section III-G).

While the experiments detailed in Annex A used scenarios with fixed goals, the above problem formulation allows the method to drive through full routes with a route planner module continually updating the goal location g^{ε} of the ego vehicle depending on its current location on the route.

### III. Method

A. System Overview

The described approach relies on two assumptions: (1) each vehicle seeks to reach some (unknown) goal location from a set of possible goals, and (2) each vehicle follows a plan generated from a finite library of defined maneuvers.

The system 200 approximates the optimal policy π* as follows: For each other vehicle, enumerate its possible goals and inversely plan for that vehicle to each goal, giving the probabilities and predicted trajectories to the goals. The resulting goal probabilities and trajectories inform the simulation process of a Monte Carlo Tree Search (MCTS) algorithm to generate an optimal maneuver plan for the ego vehicle. In order to keep the required search depth shallow and hence efficient, both inverse planning and MCTS plan over macro actions which flexibly concatenate maneuvers using context information. FIG. 2 provides an overview of the components in the system 200.

The following sections describes each of the components of the system 200 shown in FIG. 2 in further detail.

B. Maneuvers

It is assumed that, at any time, each vehicle is executing one of a finite number of maneuvers 220a. In the present example, the system 200 uses the following maneuvers: lane-follow, lane-change-left right, turn-left right, give-way, stop.

Each maneuver co specifies applicability and termination conditions. A maneuver is available in a given state if and only if the state satisfies an applicability condition of the maneuver. For example, lane-change-left is only applicable if there is a lane in same driving direction on the left of the vehicle (one could also check for space constraints). The maneuver terminates if the state satisfies the termination condition.

If applicable, a maneuver specifies a local trajectory ŝ_{1:n}ⁱ to be followed by the vehicle, which includes a reference path in the global coordinate frame and target velocities along the path. For convenience in exposition, it is assumed that ŝⁱ uses the same representation and indexing as sⁱ but in general this does not have to be the case (for example, ŝ may be indexed by longitudinal position rather than time, which can be interpolated to time indices). In the example system 200, the reference path is generated via a Bezier spline function fitted to a set of points extracted from the road topology, and target velocities are set using domain heuristics similar to [10]. Generally, the system 200 assumes that vehicles will attempt to drive at local speed limit when possible. This target is reduced to the velocity of the slower vehicle in front on same lane (if any) or as a function of local curvature on the driving path.

The give-way maneuver slows the vehicle down to some specified velocity while driving toward a given location, usually a crossing or turning point where oncoming traffic has priority. At the location, the maneuver terminates if the specified lanes are clear (allowing the vehicle to proceed with next maneuver without fully stopping), otherwise it fully stops the vehicle and then terminates once the specified lanes are clear. When used as part of the system 200, give-way is permitted to terminate early if the system 200 predicts safe entry (cf. Annex A).

The lane-follow and give-way maneuvers have open parameters in their termination conditions: for lane-follow, the parameter specifies the driving distance; for give-way, the parameter specifies lanes which must be monitored for oncoming traffic. Such open parameters are automatically set by macro actions, which we define in next section.

In contrast to methods such as MPDM [9], here, the maneuvers are separated from control. This separation serves two purposes: First, when constructing sequences of maneuvers, each maneuver must optimise its velocity profile in anticipation of subsequent maneuvers. This is not possible if control is integrated into independent policies, as in MPDM. Having access to trajectories allows the system 200 to perform a velocity smoothing operation across the concatenation of the trajectories, which is described in Section III-D. Second, maneuvers can be simulated under different control models (open-loop, closed-loop) in inverse planning and MCTS, which offer different tradeoffs between prediction accuracy and simulation efficiency.

C. Macro Actions

Macro actions 222b concatenate one or more maneuvers in a flexible way. Using macro actions relieves the planner in two important ways: they specify common sequences of maneuvers, and they automatically set the free parameters in maneuvers based on context information (usually road layout). Table I defines examples of the macro actions 222b used in the system 200. The applicability condition of a macro action is given by the applicability condition of the first maneuver in the macro action as well as optional additional conditions (see Table I). The termination condition of a macro action is given by the termination condition of the last maneuver in the macro action.

Note that macro actions as used in this context do not define a hierarchy of decomposable actions; they simply define sequences of actions.

Both inverse planning (Sec. III-F) and MCTS (Sec. III-G) search over macro actions rather than maneuvers, which significantly increases their efficiency by reducing search depth.

TABLE 1
Macro actions used in our system. Each macro action concatenates
one or more maneuvers and sets their parameters (see Sec. III-C)

| | | Maneuver sequence |
|---|---|---|
| | Additional applicability | (maneuver parameters in |
| Macro action | condition | brackets) |
| Continue | | lane-follow (end of visible |
| | | lane) |
| Continue to | Must be in roundabout | Lane-follow (next exit point) |
| new exit | and not in outer-lane | |
| Change | There is a lane to the | lane-follow (until target lane |
| left/right | left/right | clear, lane-change-left/right |
| Exit left/right | Exit point on same lane | Lane-follow (exit point), |
| | ahead of car and in | give-way (relevant lanes), |
| | correct direction | turn-left/right |
| Stop | There is a stopping goal | Lane-follow (close to |
| | ahead of the car on the | stopping point), stop |
| | current lane | |

D. Velocity Smoothing

To accommodate natural variations in driving behaviours and to obtain a feasible trajectory across maneuvers for a vehicle i, the velocity smoothing function 224 is applied to optimise the target velocities in a given trajectory ŝ_{1:n}ⁱ Let \hat{x}ₜ be the longitudinal position on the reference path at ŝₜⁱ and \hat{v}ₜ its corresponding target velocity, for 1≤t≤n. A piecewise linear interpolation of target velocities between points is denoted by κ: x→v. Given the time elapsed between two time steps, Δt; the maximum velocity and acceleration, vₘₐₓ/aₘₐₓ; and setting x₁=\hat{x}₁, v₁=\hat{v}₁, a smoothing problem is defined as

$$\begin{matrix}{{min}_{{x}_{2 : n} , {v}_{2 : n}} {\sum }_{t = 1}^{n} {\vert \vert {v}_{t} - κ ( {x}_{t} ) \vert \vert}_{2} + λ {\sum }_{t = 1}^{n - 1} \vert \vert {v}_{t + 1} - {v}_{t} \vert \vert}_{2} \\ {x}_{t + 1} = {x}_{t} + {v}_{t} Δ t \\ 0 < {v}_{t} < {v}_{max} \\ {v}_{t} \leq κ ( {x}_{t} )\end{matrix} \qquad ( 4 )$$

where λ>0 is the weight given to the acceleration part of the optimisation objective. The last constraint to treat target velocities as upper bounds results in more realistic braking behaviours in the system 200.

Equation (4) is a nonlinear non-convex optimisation problem which can be solved, e.g., using a primal-dual interior point method (e.g. IPOPT [27]). From the solution of the problem, (x_{2:n}, v_{2:n}), the system 200 interpolates to obtain achievable velocities at the original points \hat{x}ₜ. If \hat{x}ₜ≤xₙ for all t, then the system 200 can interpolate from this solution for \hat{x}_{1:n} Otherwise, the system 200 can solve a similar problem starting from xₙ, and repeat the procedure until all \hat{x}_{1:t} are within the bound.

Velocity smoothing should respect zero-velocities in the input trajectory, which indicate full stops. A simple way of achieving this is to split a trajectory into segments separated by stopping events, and to apply the smoothing function to each segment.

E. Reward Function

As noted, “reward function” and “cost function” are two ways of describing the same thing, namely a function 226 that penalizes (i.e. discourages) certain trajectory features and rewards (i.e. encourages) others. How the output of the function 226 (the reward or cost of a given trajectory) is represented numerically is immaterial, and the choice of a particular terminology (reward or cost) does not imply any particular numerical representation. Lower numerical values could represent a lower cost/higher reward or a higher cost/lower reward than higher numerical values, and the choice of terminology does not imply any restriction on this. The only requirement is that the numerical representation is consistent with the way any cost/reward optimization is performed.

In the present example, a reward of a trajectory s_{1:n} for vehicle i is defined as a weighted sum of K reward components,

Rⁱ(s_{1:n})=Σₖ₌₁^{K}wₖRₖⁱ(s_{1:n}) (5)

with weights wₖ>0 and Rₖⁱ(s_{1:n})>0. The system 200 includes reward components for execution time, longitudinal jerk, lateral jerk, path curvature, and safety distance to leading vehicle. Here, Rⁱ represents the reward function 226 for goal gᵢ in mathematical notation.

F. Goal Recognition

By assuming that each vehicle i∈ [symbol] seeks to reach one of a finite number of possible goal locations gⁱ∈ [symbol] ⁱ, using plans constructed from our defined macro actions, the inverse planner 204 uses a framework of rational inverse planning to compute a Bayesian posterior distribution over vehicle i's goals at time t (the goal probabilities 210),

p(gⁱ|s_{1:t})∝L(s_{1:t}|gⁱ)p(gⁱ) (6)

Where L(s_{1:t}|gⁱ) is the likelihood of i's observed trajectory given goal gⁱ, and p(gⁱ) specifies a prior probability of the goal gⁱ.

The likelihood is a computed as function of the reward difference between two plans: the reward \hat{r} of the optimal trajectory from i's initial observed state s₁ⁱ to goal gⁱ after velocity smoothing, and the reward r̅ of the trajectory which follows the observed trajectory until time t and then continues optimally to goal gⁱ with smoothing applied only to the trajectory after t. Then, the likelihood is defined as

L(s_{1:t}|gⁱ)=exp(−β(\hat{r}−r̅)) (7)

where β is a scaling parameter (e.g. β=1). This definition assumes that vehicles behave rationally by driving optimally to achieve goals, but allows for a degree of deviation. If a goal cannot be achieved, we its probability is set to zero.

Velocity smoothing is not applied to the part of the trajectory that has already been observed, i.e. s_{1:t}. Otherwise, the effect of velocity smoothing could be to wash out evidence that would hint at certain goals.

Algorithm 1 shows pseudo code for an implementation of the goal recognition algorithm, with further details in below subsections. The algorithm allows for efficient parallel processing by using parallel threads for each vehicle i, goal gⁱ and rewards \hat{r}, r̅.

| Algorithm 1: Goal recognition algorithm: | |
|---|---|
| Input: vehicle i, current maneuver ωⁱ, observations s_{1:t} | |
| Returns: goal probabilities p(gⁱ\|s_{1:t},ωⁱ) | |
| 1. | Generate possible goals gⁱ ϵ [symbol] ⁱ from state sₜⁱ |
| 2. | Set prior probabilities p(gⁱ) (e.g. uniform) |
| 3. | For all gⁱ ϵ [symbol] ⁱ do: |
| | ŝ_{1:n}ⁱ ← A * SEARCH (ωⁱ) from ŝ₁ⁱ to gⁱ |
| | Apply velocity smoothing to ŝ_{1:n}ⁱ |
| | \hat{r} ← reward Rⁱ (ŝ_{1:n}ⁱ) |
| | s̅_{1:m}ⁱ ← A* SEARCH(ωⁱ) from s̅ⁱ to gⁱ, with s̅_{1:t}ⁱ = s_{1:t}ⁱ |
| | Apply velocity smoothing to s̅_{t+1:m}ⁱ |
| | r̅ ← reward Rⁱ (s̅_{1:m}ⁱ) |
| | L(s_{1:t}\|Gⁱ) ← exp( − β(r̅ − \hat{r})) |
| | Return p(gⁱ\|s_{1:t}) ∝ L(s_{1:t}\|gⁱ) p(gⁱ) |

1) Goal Generation: A heuristic function is used to generate a set of possible goals [symbol] ⁱ for vehicle i based on its location and context information such as road layout and traffic rules. The system 200 defines one goal for the end of the vehicle's current road and goals for end of each reachable connecting road, bounded by the ego vehicle's view region (e.g. as shown in FIG. 1). Infeasible goals, such as locations behind the vehicle, are not included.

In addition to static goals which depend only on the vehicle's location and road layout/rules, dynamic goals can be defined, e.g. which depend on current traffic. For example, in the dense merging scenario considered below in Annex A, stopping goals are dynamically added to model a vehicle's intention to allow the ego vehicle to merge in front of the vehicle.

2) Maneuver Detection: Maneuver detection is used to detect the current executed maneuver of a vehicle (at time t), allowing inverse planning to complete the maneuver before planning onward. A maneuver detection module of the system 200 computes probabilities over current maneuvers, p(ωⁱ) for each vehicle i. One option is Bayesian changepoint detection algorithms such as CHAMP [19]. Maneuver detection methods are known per se, and are therefore not described in further detail. In the experiments detailed below, a simulated detector was used.

As different current maneuvers may hint at different goals, inverse planning is performed for each possible current maneuver for which p(ωⁱ)>0. Thus, each current maneuver produces its own posterior probabilities over goals, denoted by p(gⁱ|s_{1:t},ωⁱ) For efficiency, the inverse planning may be limited to some subset of maneuvers such as the most-likely maneuver(s).

3) Inverse Planning: Inverse planning is done using A* search [12] over macro actions. A* starts after completing the current maneuver ωⁱ which produces the initial trajectory ŝ_{1:τ} Each search node q corresponds to a state s∈ [symbol] , with initial node at state ŝ_{τ} and macro actions are filtered by their applicability conditions applied to s. A* chooses the next macro action leading to a node q′ which has lowest estimated total cost to goal gⁱ, given by f(q′)=l(q′)+h(q′).

Here, the term “cost” is used in keeping with standard A* terminology and to differentiate the simpler cost definition used by the A* search from the reward function defined in Sec. III-E. The cost h is approximating the reward by considering only travel time (see below), which is sufficient for the purpose of the A* search. However, different forms of cost/reward can be defined in this context.

The cost l(q′) to reach node q′ is given by the driving time from i's location in the initial search node to its location in q′, following the trajectories returned by the macro actions leading to q′. The cost heuristic h(q′) to estimate remaining cost from q′ to goal gⁱ is given by the driving time from i's location in q′ to goal via straight line at speed limit. This definition of h(q′) is admissible as per A* theory, which ensures that the search returns an optimal plan. After the optimal plan is found, a complete trajectory ŝ_{1:n}ⁱ is extracted from the maneuvers in the plan and the initial segment ŝ_{1:τ} from the current maneuver.

To minimise the computational cost of inverse planning, in the present implementation, macro actions are executed using open-loop control. This means that trajectories are simulated using an idealised driving model which executes the trajectory with linearly-interpolated target velocities. Second, the system 200 operates on the assumption that all other vehicles not planned for use a constant-velocity lane-following model after their observed trajectories. This assumption allows give-way maneuver and change left/right macro actions to predict when traffic will be clear. Third, no smoothing is applied during search and a surrogate cost definition based only on approximate driving time is used. Finally, there is no check for collisions during inverse planning; due to the use of open-loop control and constant velocities of other vehicles, there may be situations where collisions happen inevitably (note that predicted collisions are still detected and accounted for, just not in this specific context—see below). These simplifications result in a level of abstraction which has low computational cost and is sufficiently informative for the goal probabilities. However, it will be appreciated that this is merely one possible implementation, and that other design choices can be adopted in other implementations.

4) Trajectory Prediction: In this example, the system 200 predicts multiple plausible trajectories 212 for a given vehicle and goal, rather than a single optimal trajectory. This is beneficial because there are situations in which different trajectories may be (near)optimal but may lead to different predictions which could require different behaviour on the part of the ego vehicle.

To predict multiple trajectories and associated probabilities to a given goal, a second A* search is run for a fixed amount of time and is free to compute a set of plans with associated rewards (up to some fixed number of plans). Any time A* search finds a node that reaches the goal, the corresponding plan is added to the set of plans. The A* search may find trajectories that do not reach the goal, but those are not added to the set of plans considered in the next stage. Given a set of computed trajectories {ŝ_{1:n}ⁱ|ωⁱ,gⁱ}_{k=1 . . . K} to goal gⁱ with initial maneuver ωⁱ and associated reward rₖ=Rⁱ(ŝ_{1:n}^{i,k}) after smoothing, a distribution is computed over the trajectories by using a Boltzmann distribution:

$$p ( {\hat{s}}_{1 : n}^{i , k} ) = η exp ( γ {r}_{k} ) \qquad ( 8 )$$

where γ is a scaling factor (e.g. γ=1) and η is a normaliser. This encodes the assumption that trajectories which are closer to optimal (in terms of their reward) are more likely.

G. Ego Vehicle Planning

To compute an optimal plan for the ego vehicle, the goal probabilities and trajectory predictions are used to inform a Monte Carlo Tree Search (MCTS) algorithm [6]. MCTS combines statistical back-propagation operators used in temporal-difference reinforcement learning [25] with a dynamic tree expansion to focus the search on the current state. Algorithm 2 gives pseudo code of an implementation of the MCTS algorithm (this implementation of the algorithm is a “rollout-based” version of MCTS [16]).

Algorithm 2: Monte Carlo Tree Search algorithm
Returns: optimal maneuver for ego vehicle ε in state sₜ
Perform D simulations:

| | |
|---|---|
| 1. | Search node q.s ← sₜ(root node) |
| 2. | Search depth d ← 0 |
| 3. | For all i ϵ [symbol] \ {ε} do |
| | Sample current maneuver ωⁱ ~ p(ωⁱ) |
| | Sample goal gⁱ ~ p(gⁱ\|ŝ_{1:t}ⁱ, ωⁱ) |
| | Sample trajectory ŝ_{1:n}ⁱ ϵ {ŝ_{1:n}^{i,k}\|ωⁱ, gⁱ) with p(ŝ_{1:n}^{i,k}) |
| 4. | While d < dₘₐₓ do |
| | Select macro action μ for ε applicable in q.s |
| | ŝ_{τ:l} ← Simulate macro action until it terminates, with other vehicles following their |
| | sampled trajectories ŝ_{1:n}ⁱ |
| | r ← ∅ |
| | If ego vehicle collides during ŝ_{τ:l} then |
| | r ← r_{coll} |
| | Else if ŝₗ^{ε} achieves ego goal then |
| | r ← R^{ε} (ŝ_{t:n}) |
| | Else if d = dₘₐₓ − 1 then |
| | r ← rₜₑᵣₘ |
| | if r ≠ ∅ then |
| | Use (9) to backprop r along search branches (q, μ, q′) that generated the |
| | simulation |
| | Start next simulation |
| | q′.s = ŝₗ; q ← q′; d ← d + 1 |

Return maneuver for ε in sₜ, μ ϵ argmax_{μ} Q(root, μ).

The algorithm performs a number of simulations ŝ_{t:n} starting in the current state ŝₜ=sₜ down to some fixed search depth or until a goal state is reached. At the start of each simulation, for each other vehicle, a current maneuver is sampled, then a goal, and then a trajectory for the vehicle using the associated probabilities (cf. Section III-F).

Sampling gⁱ from the mixed posterior Σ_{ω}_{ⁱ}p(gⁱ|s_{1:t},ωⁱ)p(ωⁱ) is avoided because examples could be constructed where this may lead to incompatible sampling of ωⁱ/gⁱ (i.e. gⁱ cannot be achieved after ωⁱ).

The sampled trajectories will be used to simulate the motion of the other vehicles, in closed-loop or open-loop modes (detailed below). As in A* search, each node q in the search tree corresponds to a state s∈ [symbol] and macro actions are filtered by their applicability conditions applied to s. After selecting a macro action μ using some exploration technique (e.g. UCB1 [3]), the state in current search node is forward-simulated based on the trajectory generated by the macro action and the sampled trajectories of other vehicles, resulting in a partial trajectory ŝ_{τ:ι} and new search node q′ with state ŝ_{ι}.

Collision checking is performed on ŝ_{τ:ι} to check whether the ego vehicle collided, in which case the reward is set to r←r_{coll} which is back-propagated according Equation (9), below, where r_{coll} is a method parameter.

Otherwise, if the new state ŝ_{ι} achieves the ego goal g^{ε} the reward for back-propagation is computed as r=R_{ε}(ŝ_{t:n})—i.e. as the reward of the trajectory computed as per Equation (5); in this case, this is the same reward function 226 that is used to evaluate possible trajectories of other agents (which assumes that other vehicles reason in a similar way to the ego vehicle).

If the search reached its maximum depth dₘₐₓ without colliding or achieving the goal, the reward is set as r←rₜₑᵣₘ, which can be a constant or based on heuristic reward estimates similar to A* search.

The reward r is back-propagated through search branches (q, ω, q′) that generated the simulation, using a 1-step off-policy update function defined by

$$Q ( q , μ ) ← Q ( q , μ ) + \{ \begin{matrix}{δ}^{- 1} [ r - Q ( q , μ ) ] if q leaf node , else \\ {δ}^{- 1} [ {max}_{{μ}^{′}} Q ( {q}^{′} , {μ}^{′} ) - Q ( q , μ ) ]\end{matrix} \qquad ( 9 )$$

where δ is the number of times that macro action μ has been selected in q. After the simulations are completed, the algorithm selects the best macro action for execution in sₜ from the root node, argmax_{μ} Q(root,μ).

The MCTS algorithm is re-run at a given frequency to account for new observations since the last MCTS call (information from the past search tree is not reused).

In Algorithm 2, the index τ in line 9 is used to denote the current time point in the generated simulation (not necessarily the current time point in “real world”). In the first simulation iteration with d=0, τ←t (current time), i.e. the simulation commences from t, and the macro action terminates at time t. For the next iteration, τ←ι (i.e. the finish time of the previous simulation iteration, etc.

Simulation starts from current time t, so the past trajectory is not part of the sampled trajectories. The first iteration (for d=0) would always start from each agent's observed state at time t. To reflect this, the notation for the samples trajectory in line 6 in Algorithm 2 (and elsewhere) may be written as ŵ_{t:n}ⁱ∈{ŝ_{t:n}^{i,k}|ωⁱ,gⁱ} where ŝₜⁱ is always equal to sₜⁱ (actual trajectory at time t).

Two different control modes are used to simulate maneuvers and macro actions. The ego vehicle's motion always uses closed-loop mode, while other vehicles can be simulated in either closed-loop or open-loop mode.

1) Closed-Loop Simulation: Closed-loop simulation uses a combination of proportional control and adaptive cruise control (ACC). Two independent proportional controllers control the acceleration and steering of the vehicle. If there is another vehicle close ahead of the controlled vehicle, control is given to ACC which keeps the vehicle at a safe distance to the leading vehicle. No velocity smoothing is applied since the combination of P/ACC control achieves approximately smooth control. Termination conditions in maneuvers are monitored in each time step based on the vehicle's observations. ACC is known per se, and therefore the details of the ACC algorithm are not described herein.

2) Open-Loop Simulation: Open-loop simulation works in the same way as in A* search (see Sec. III-F3), by setting the vehicle's position and velocity directly as specified in trajectory. Hence, there is no automatic distance keeping in open-loop control. Velocity smoothing is applied to the trajectory to improve realism of the prediction. Termination conditions in maneuvers such as “wait until oncoming traffic is clear”, e.g. as used in give-way maneuver, are realised by waiting until traffic is predicted to be clear assuming that non-controlled vehicles use a constant-velocity lane-following model.

The system 200 thus integrates planning and prediction over extended horizons, by leveraging the computational benefit of utilising a finite maneuver library. Prediction over extended horizons is made possible by recognising the goals of other vehicles via a process of rational inverse planning. The evaluation set out in Annex A showed that the system 200 robustly recognises the goals of other vehicles in diverse urban driving scenarios, resulting in improved decision making while allowing for intuitive interpretations of the predictions to justify (explain) the system's decisions. The system 200 is general in that it uses relatively standard planning techniques which could be replaced with other related techniques, e.g., POMDP-based approximate planners [23]. Furthermore, while the above examples focused on prediction of other vehicles, the principles underlying the system 200 are general and could be extended to include prediction of other traffic participants such as cyclists, or applied to other domains in which mobile robots interact with other robots/humans. The system 200 may also be extended to account for human irrational biases.

Example Goal Detection:

By way of further illustration, an example computation of goal probabilities will now be described.

The following description refers to observations O, which comprise the observed states agent in the above context.

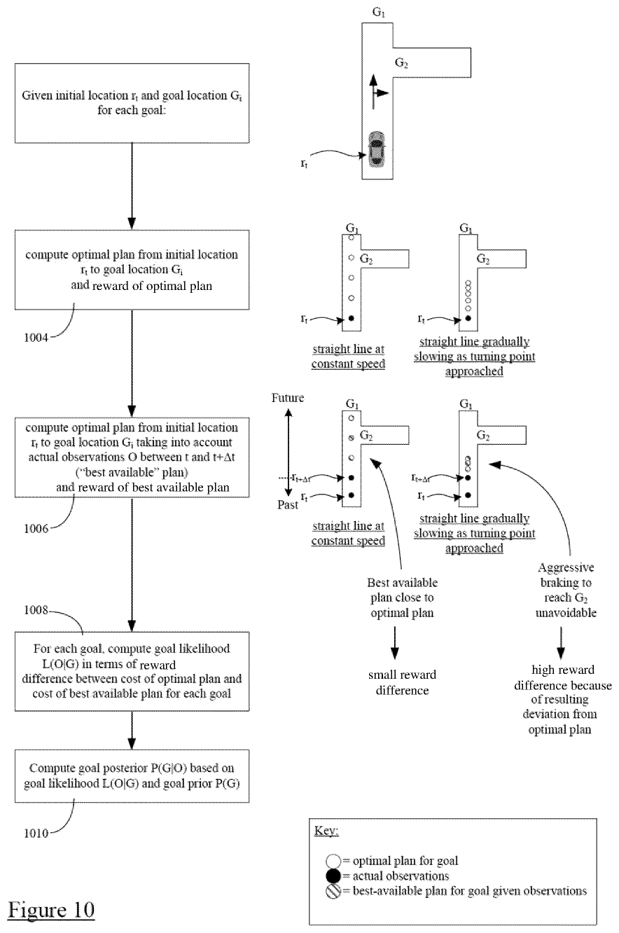

FIG. 10 shows a schematic flowchart for an inverse planning method of probabilistically inferring a goal of an external actor, from a finite set of available goals, based on reward differences. This is one example of an inverse planning method implemented by the inverse planner 204.

The right-hand side of FIG. 10 shows an illustrative example of the steps applied to a scenario with two available goals:
1. G₁- continuing along the current road, which is defined as a goal location at the end of the visible road (more generally, as a reference point ahead of the car on the current road);
2. G₂- taking a right-turn exist, defined in terms of an exit location.

Given a set of possible goals for an observed car and a sequence of past basic maneuvers executed by the car, a posterior distribution over the goals can be computed using a process of inverse planning. As described above, the method computes a Bayesian posterior, P(G|O)˜L(O|G) P(G), over the possible goals G given a sequence of observations O (e.g. an observed trace τₙ, as in the above examples), a prior distribution P(G) over goals, and the likelihood function L(O|G).

A goal is defined in terms of a goal location, and the notation Gᵢ may be used to represent the goal location for that region. The goal location Gᵢ can be a point in space, but can also be region or could correspond to a particular distance along the road, e.g. a goal location could be defined as a line perpendicular to the road and in that case the car is said to have reached the goal once it reaches that line (irrespective of its lateral position in the road).

The likelihood L(O|Gᵢ) for a given goal Gᵢ∈G is defined as the difference between the respective rewards of two plans:
1. an optimal plan from the car's initial location rₜ (at time t) to the goal location Gᵢ, i.e. the optimal plan to get from rₜ to Gᵢ irrespective of any observed behaviour of the car after time t. This could be executed as a basic maneuver, a macro action or a sequence of multiple basic maneuvers other than a macro action. With multiple basic maneuvers, the partial trajectories associated therewith are combined to provide an optimal full trajectory for reaching the goal Gᵢ from the initial position rₜ (irrespective of any actual observed behaviour of the car after time t); and
2. a “best available” plan—this is defined as an optimal plan from rₜ to the goal location Gᵢ given any observed behaviour of the car between time t and time t+Δt, i.e. the best plan to get from rₜ to Gᵢ with the additional constraint that this plan must match the behaviour actually observed in the subsequent time interval ΔT. In other words, as the optimal plan from the car's initial location rₜ to goal Gᵢ such that the plan respects the observations O. This assumes that cars are more likely to execute optimal plans to achieve goals but allows for a degree of deviation. This could also be executed as a basic maneuver, a macro action or a sequence of multiple basic maneuvers other than a macro action. With multiple basic maneuvers, the partial trajectories associated therewith are combined to provide a “best available” full trajectory for reaching the goal Gᵢ from the initial position rₜ but taking into account the actual observed behaviour of the car in the interval from t to t+Δt. The best available trajectory has an observed portion for the interval [t, t+Δt] which matches the actual observed trajectory and a future portion for a subsequent time interval, chosen so as to minimize an overall reward associated with best available full trajectory (i.e. the full reward of both the observed portion and the future portion).

This is a form of goal recognition because it considers the full path to reach the goal (which may be based on multiple partial trajectories associated with multiple maneuvers).

The reward assigned to a full trajectory can take into account various factors as described later. These include driving time (penalizing trajectories that take longer to reach a goal), safety (penalizing unsafe trajectories) and comfort (e.g. penalizing trajectories with excessive jerk).

The car's initial location rₜ may for example be the first observed location of the car. A reasonable approach is to use a moving window of past observations defined by the ego car's sensor ranges to define the initial location rₜ.

An optimal plan (1 above) is computed for each goal G₁, G₂ at step 1004 in FIG. 10. Once computed, this allows an optimal trajectory to be determined for each goal G₁, G₂, for example, using an A* search (see below for details). Having computed the optimal trajectory, a full reward associated with the optimal trajectory can then be computed (also described below). The optimal trajectory is a full trajectory, i.e. for reaching the goal in question from the initial location rₜ.

In the example of FIG. 10, trajectories are denoted by points along the trajectory that are evenly spaced in time, such that evenly-spaced points imply constant velocity and increasing (resp. decreasing) distance between points implies acceleration (resp. deceleration). White circles are used to represent optimal trajectory points. It can thus be seen that, for goal G₁, the optimal trajectory is a straight-line path continuing along the road at constant speed, whereas for goal G₂ the optimal trajectory gradually slows as the car approaches a turning point for the exit.

A best available plan (2 above) is computed for each goal G₁, G₂ at step 1006. As indicated, these take into account actual observations O between time t (when the car was at its initial location rₜ) and a current time t+Δt. Those observations O may comprise the observed low-level trace τ, represented in FIG. 10 using black circles.

In that context, the observations O may alternatively or additionally comprise a current maneuver of the car, i.e. the probability of each goal may estimate in dependence on a maneuver currently being executed by the car. They may additionally include past observed maneuvers.

Although not shown explicitly in FIG. 10, as described above, probabilistic maneuver detection is applied to predict a probability distribution over possible current maneuvers for the car. Hence, the current maneuver may not be known definitely but only probabilistically, in terms of a distribution p(M|τ) over possible current maneuvers. In that case, during the planning process, at the start of each MCTS rollout, firstly a current maneuver Mⱼ is sampled from p(M|τ) and then a goal is sampled from the goal probability distribution p(G|O) for that current maneuver Mⱼ (i.e. with the observations O comprising Mⱼ).

From the best available plan, a best available trajectory can be determined (see below for details), which in turn allows a full reward to be determined for the best available trajectory (also described below). This is also a full trajectory in the sense of being a complete trajectory from the initial location rₜ to the goal location Gᵢ. The best available trajectory has an observed portion between time t and t+Δt that matches the actual observed trajectory (i.e. the black circles in FIG. 10) and additionally includes a future portion for the time after t+ΔT, represented in FIG. 10 using diagonally shaded circles.

In the depicted example, it can be seen that both the observed portion (black circles) and the future portion (diagonally shaded circles) of the best available trajectory for goal G₁ match the optimal trajectory (white circles) for that goal G₁ reasonably well. Therefore, the reward difference for goal G₁- being the difference between the reward of the optimal trajectory and the reward of the best available trajectory—is relatively low.

However, for goal G₂, the observed trajectory (black circles) deviates from the optimal trajectory (white circles) fairly significantly, because the car has failed to by time t+Δt to the extent required by the optimal trajectory. This discrepancy will not necessarily cause a significant reward difference per se (it may or may not depending on the details of the implementation). However, as a consequence of the observed behaviour, it can be seen that the future portion of the best available trajectory (i.e. the portion after time t+Δt) must necessarily include sharp braking (which reflects the fact that the highest-reward path from the car's current location to G₂ must involve sharp braking given the circumstances of the car)—which is penalized by the reward function. This discrepancy from the reward of the optimal trajectory means a higher reward difference for the goal G₂.

At step 1008, for each goal G₁, G₂, the goal likelihood L(O|G) is computed in terms of the reward difference between the optimal plan computed at step 1004 and the best available plan computed at step 1006 for that goal. This, in turn, allows the goal posterior P(G|O) to be computed (step 1010) based on the goal likelihood and the goal prior.

The prior P(G) can be used to encode knowledge about the “inherent” probability of certain goals. For example, it may be observed, in the scenario of FIG. 10, that cars take the right-turn exist relatively infrequently, which could be encoded as a prior with P(G₂)<P(G₁). This would effectively bias goal G₁ in favour of G₂. For scenarios without this prior knowledge, each goal could simply be assumed to be equally probable absent any observations of a specific car's individual behaviour, i.e. P(G₁)=P(G₂), as in the example of Algorithm 2, where uniform goal prior distribution is used.

The above assumes that, given a goal, an optimal plan for that goal can be determined given the car's initial location rₜ, and a best available plan for that goal can be determined given the observations in the subsequent time interval ΔT. It moreover assumes that, given an optimal (resp. best available) plan, an optimal (resp. best available) trajectory can be determined. One mechanism for mapping goals to plans to trajectories in this manner uses an A* search, as described above.

Example Current Maneuver and Goal Sampling:

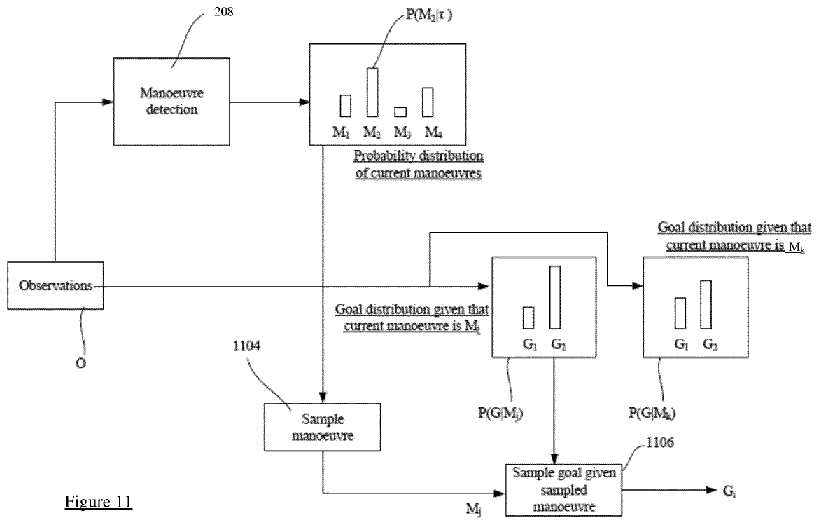

FIG. 11 shows schematic overview of a mechanism by which the results of inverse planning can be applied as part of MCTS roll out, by the maneuver planner 218. This applies principles described above in relation to Algorithm 2, in which MCTS is performed multiple times with different samplings of the probabilistic predictions about other agent(s).

The maneuver detector 208 detects a current maneuver probability distribution for the target actor in the manner described above. For each maneuver Mᵢ∈M (M being the finite set of available maneuvers), this provides a probability that the target actor is currently implementing that maneuver, given an observed trajectory τ, i.e.

P(M|τ).

Each MCTS rollout starts as follows. For each other car:

1. Sample a current maneuver from the set of predicted current maneuvers and their probabilities, i.e. sample a current maneuver Mⱼ based on P(M|τ) (block 1104);

2. Sample a goal from the goal posterior P(G|O) corresponding to the sampled current maneuver, i.e. apply the inverse planning steps above with the sampled current maneuver Mⱼ (block 1106).

These samples, i.e. the sampled current maneuver Mⱼ and the sampled goal G_{L} are used throughout the entire rollout of the MCTS process. Steps 1 and 2 above would be performed at the start of each MCTS rollout and the samples goal and trajectory used throughout that rollout.

In FIG. 11, the shorthand notation P(G|Mⱼ) and P(G|Mₖ) is used to denote the goal posteriors given a current maneuver Mⱼ and Mₖ respectively—noting that the observations O may be more extensive than simply the current maneuver (e.g. encompassing a sequence of previous maneuver(s)). Using this notation, if at step 1 above, maneuver Mⱼ is sampled, then the goal posterior P(G|Mⱼ) would be sampled from at step 2; whereas if Mₖ is sampled, the goal posterior P(G|Mₖ) would be used.

Although not depicted in FIG. 11, trajectory probabilities would be determined for the goal, e.g. using A* search, in the manner described above.

Example Search Tree:

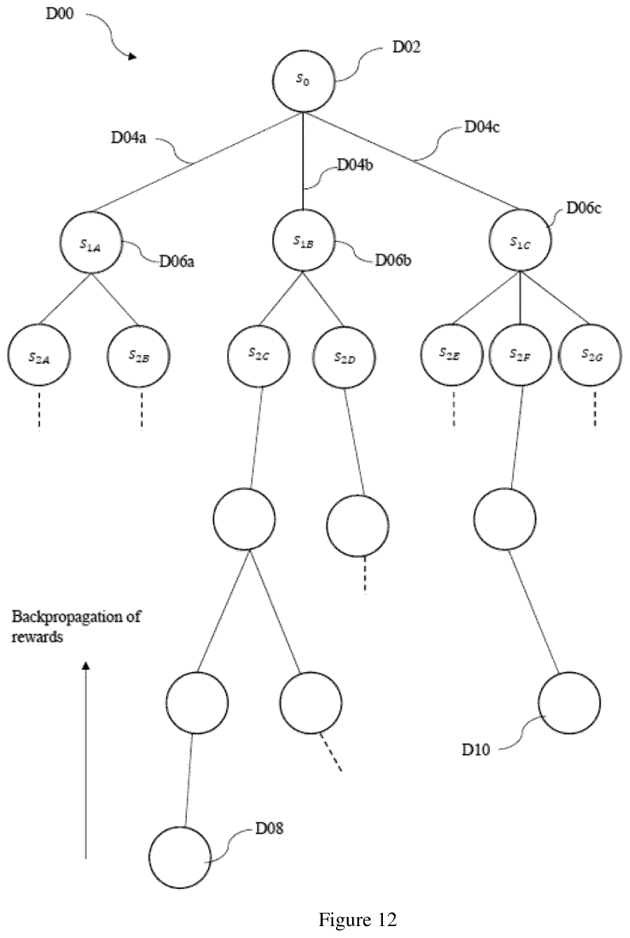

FIG. 12 shows an example of a Monte-Carlo Tree that might be constructed in applying Algorithm 2 above.

By way of example, FIG. 12 shows edges D04a-c from the root node D02 to three direct child nodes of the root node, labelled D06a-c respectively. Each of those edges D04a-c represents a different maneuver that may be performed given the state s₀ of the driving scenario of the node from which they extend (the root node D02 in this instance). Each of those children represents a subsequent state of the driving scenario—s_{1A}, s_{1B}, s_{1C} respectively—that is predicted in the event that the corresponding maneuver is performed by the ego vehicle, starting from state s₀.

For example, the edges D04a-c may correspond respectively to “follow lane”, “switch lane left”, and “switch lane right” in a multi-lane driving scenario with respect to the parent state s₀. In the state s₀, the ego vehicle is in a current lane—the follow lane maneuver is performed to stay in the current lane over the applicable time interval; switch lane left and right are performed to attempt a move to a lane to the left and right of the current lane respectively. The states s_{1A}, s_{1B}, sic are obtained by progressing the parent state s₀ in accordance with the relevant maneuver, taking into account the external agent behaviour over the relevant time interval.

Each rollout of Algorithm 2 would explore a branch of the tree, until the relevant terminating condition is met (collision, reaching goal, or reaching maximum depth). By way of example, leaf nodes D8, D10 at the end of their respective branches are show, which could be noted at which a collision occurs, or the goal is reached, or at the maximum depth. Individual nodes within a given branch correspond to states simulated in the corresponding iteration of the simulation phase of that rollout.

The above techniques be implemented in an “onboard” or “offboard” context. In an offboard context, the above technicians may be implemented in a planner of a mobile robot to plan actions in real-time. In that case, observations may be derived from sensors signals captured using its onboard sensor(s). In an offboard context, the above techniques can also be implemented within a planner of a simulated runtime stack in order to test the performance of the runtime stack based on simulated driving scenarios. Simulation is an increasingly crucial component of safety and other performance testing for autonomous vehicles in particular.

Note the distinction between offboard simulation and simulation that is inherent to the planning process. In the above, multiple simulations are run in order to assess and plan ego actions/maneuvers. This is part of the planning process, and those simulations would be run both in an onboard or offboard context. In an onboard context, the observed agent trajectory would be derived from real, physical sensor measurements in real time. In an offboard context, the observed agent trajectory would be simulated, and the planning and prediction process would be applied to simulated agent observations for the purpose of safety or other performance testing, training and the like.

Example AV Stack

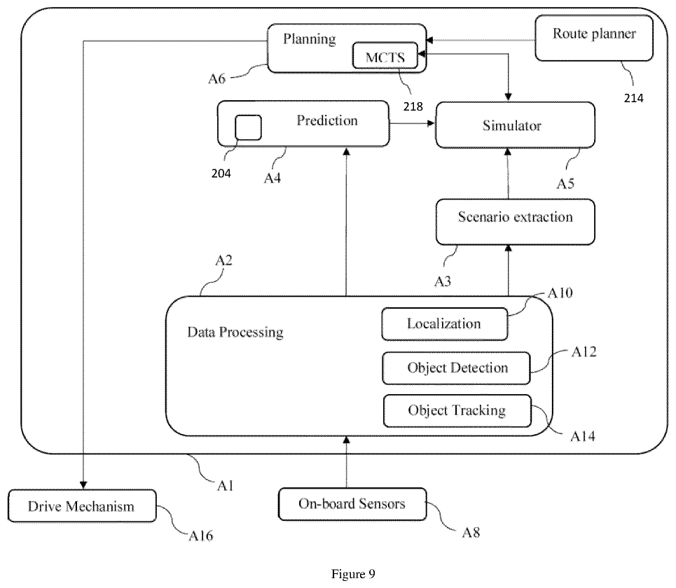

FIG. 9 shows a highly schematic functional block diagram of certain functional components of an AV runtime stack A1, namely a perception component A2, prediction component A4 and an AV planner A6.

The perception component A2 receives sensor data from an on-board sensor system A8 of the AV. The on-board sensor system A8 can take different forms but generally comprises a variety of sensors such as image capture devices (cameras), LiDAR units etc., satellite-positioning sensor(s) (GPS etc.), motion sensor(s) (accelerometers, gyroscopes etc.) etc., which collectively provide rich sensor data from which it is possible to extract detailed information about the surrounding environment and the state of the AV and other actors (vehicles, pedestrians etc.) within that environment.

The route planner 214 is shown in FIG. 9, and the inverse planner 204 and MCTS-based maneuver planner 218 are shown as part of the prediction and planning components A4, A6 respectively.

Note however that the present techniques are not limited to using image data and the like captured using on-board optical sensors (image capture devices, lidar etc.) of the AV itself. The method can alternatively or additionally be applied using externally-captured sensor data, for example CCTV images etc. captured by external image capture units in the vicinity of the AV. In that case, at least some of the sensor inputs used to implement the method may be received by the AV from external sensor data sources via one or more wireless communication links.

The perception component A2 processes the sensor data in order to extract such information therefrom. This will generally involve various forms of machine learning (ML)/artificial intelligence (AI) processing. Functions of the perception component A2 that are relevant in the present context include localization (block A10), object detection (block A12) and object tracking (block A14).

Localization is performed to provide awareness of the surrounding environment and the AV's location within it. A variety of localization techniques may be used to this end, including visual and map-based localization.

Object detection is applied to the sensor data to detect and localize external objects within the environment such as vehicles, pedestrians and other external actors whose behaviour the AV needs to be able to respond to safely. This may for example comprise a form of 3D bounding box detection, wherein a location, orientation and size of objects within the environment and/or relative to the ego vehicle is estimated. This can for example be applied to (3D) image data such as RGBD (red green blue depth.), LiDAR point cloud etc. This allows the location and other physical properties of such external actors to be determined on the map.

Object tracking is used to track any movement of detected objects within the environment. The result is an observed trajectory of each agent that is determined over time by way of the object tracking. The observed trajectory is a history of the moving object, which captures the path of the moving object over time, and may also capture other information such as the object's historic speed, acceleration etc. at different points in time.

Used in conjunction, object detection and object tracking allow external actors to be located and tracked comprehensively on the determined map of the AV's surroundings.

Object detection and object tracking are well-known per-se, and can be performed in the present context using various publicly available state-of-the-art models.

Through the combination of localization, object detection and object tracking, the perception component A2 provides a comprehensive representation of the ego vehicle's surrounding environment, the current state of any external actors within that environment (location, heading, speed etc. to the extent they are detectable), as well as the historical traces of such actors which the AV has been able to track. This is continuously updated in real-time to provide up-to-date location and environment awareness.

The prediction component A4 uses this information as a basis for a predictive analysis, in which it makes predictions about future behaviour of the external actors in the vicinity of the AV. Examples of suitable prediction methodologies are described below.

The AV planner A6 uses the extracted information about the ego's surrounding environment and the external agents within it, together with the behaviour predictions provided by the prediction component A4, as a basis for AV planning. That is to say, the predictive analysis by the prediction component A4 adds a layer of predicted information on top of the information that has been extracted from the sensor data by the data processing component, which in turn is used by the AV planner A6 as a basis for AV planning decisions. This is generally part of hierarchical planning process, in which the AV planner A6 makes various high-level decisions and then increasingly lower-level decisions that are needed to implement the higher-level decisions. The end result is a series of real-time, low level action decisions. In order to implement those decisions, the AV planner A6 generates control signals, which are input, at least in part, to a drive mechanism A16 of the AV, in order to control the speed and heading of the vehicle (e.g. though steering, breaking, accelerating, changing gear) etc. Control signals are also generated to execute secondary actions such as signalling.

A scenario extraction component A3 determines an encountered driving scenario for the ego vehicle using outputs of the perception component A2. The determined driving scenario comprises driving scenario parameters which are extracted from the captured sensor data, and which provide a representation of a real-world scenario that has been encountered by the AV that is concise but sufficiently detailed to be used as a basis for realistic simulations. This is formulated in a structured scenario description language which can be used as a basis for such simulations.

A simulator A5 receives the parameters of the encountered driving scenario and can run simulations based on those parameters. These are the simulations inherent to the MCTS planning process, as set out above.

A function of the prediction component A4 is to model predicted external agent behaviours to be run as part of the simulations. That is, to execute an external agent behaviour model for predicting the behaviour of any external actors in the encountered driving scenario so that the predicted behaviour can be incorporated into the simulations on which maneuver planning is based.

In an offboard simulation contact, some or all the components of the runtime stack A1 could be run in exactly the same way, but on simulated inputs, such as simulated agent trajectories.

References herein to components, functions, modules and the like, denote functional components of a computer system which may be implemented at the hardware level in various ways. This includes various components of FIG. 1 and the goal recognition module 202 and the ego planning module 212 of FIG. 2, as well as their various sub-modules. A computer system comprises one or more computers that may be programmable or non-programmable. A computer comprises one or more processors which carry out the functionality of the aforementioned functional components. A processor can take the form of a general-purpose processor such as a CPU (Central Processing unit) or accelerator (e.g. GPU) etc. or more specialized form of hardware processor such as an FPGA (Field Programmable Gate Array) or ASIC (Application-Specific Integrated Circuit). That is, a processor may be programmable (e.g. an instruction-based general-purpose processor, FPGA etc.) or non-programmable (e.g. an ASIC). Such a computer system may be implemented in an onboard or offboard context.

A first aspect herein computer-implemented method of autonomously planning ego actions for a mobile robot in the presence of at least one agent, the method comprising: receiving an observed trajectory of the agent; in a sampling phase: sampling a goal for the agent from a set of available goals based on a probabilistic goal distribution, the observed trajectory used to determine the probabilistic goal distribution, and sampling an agent trajectory, from a set of possible trajectories associated with the sampled goal, based on a probabilistic trajectory distribution, each trajectory of the set of possible trajectories reaching a location of the associated goal; and in a simulation phase: selecting for the mobile robot an ego action from a set of available ego actions, and based on the selected ego action, the sampled agent trajectory, and a current state of the mobile robot, simulating (i) behaviour of the mobile robot, and (ii) simultaneous behaviour of the agent, in order to assess the viability of the selected ego action given the current mobile robot state.

The method may comprise in a goal recognition phase: computing the goal distribution by determining, for each goal, a reward difference between (a) a first substantially optimal trajectory from an initial state of the observed trajectory to the location of the goal, and (b) a best-available trajectory that combines (b.i) the observed trajectory from the initial state to a current state of the observed trajectory with (b.ii) a second substantially optimal trajectory from the current state to the location of the goal, wherein the probabilistic trajectory distribution is determined by determining a reward of each trajectory of the set of possible trajectories.

The probabilistic trajectory distribution may comprise a probability of each available goal given the observed trajectory, computed as a product of a prior probability of the goal with a likelihood of the observed trajectory given the goal, the likelihood based on an exponential of the reward difference.

The probabilistic trajectory distribution may comprise a probability of each of the possible trajectories, based on an exponential of the reward of that trajectory.

The reward of each trajectory and the reward difference of each goal may be determined using a reward function that rewards reduced travel time whilst penalizing unsafe trajectories.

The reward function may also penalize lack of comfort.

The sampled agent trajectory may be open loop, but the simulation phase may be closed loop with a simulated closed loop agent trajectory being determined based on the sampled open loop agent trajectory, the simulated closed loop trajectory deviating from the sampled open loop trajectory in a manner reactive to the simulated behaviour of the mobile robot.

Alternatively, the sampled agent trajectory may be open loop, and the simulation phase may be open loop.

The goal recognition phase may be open loop.

Each trajectory may have a path component and a motion component.

Each trajectory may take the form of a sequence of states, each state encoding spatial information and motion information at a particular time instant.

The motion component may be used as a target, from which the agent is permitted to deviate in the simulation phase in a reactive manner (e.g. with the closed loop form of simulation above).

The first and second trajectories may be determined in a first search process, which seeks to optimize a reward or estimated cost of the first and second trajectories.

An estimated cost may be used in the trajectory search process, and the estimated cost may consider travel time to the goal location only and may ignore at least one other cost factor accounted for in determining the reward difference between the first trajectory and the best-available trajectory.

The set of possible trajectories may be determined in a second search process, which may be free to explore additional trajectories, including trajectories that do not reach the location of the goal, but trajectories found in the second search process may only be added to the set of possible trajectories if they do reach the location of the associated goal.

The first and/or second search process may be performed over a search space of possible agent actions, wherein each trajectory corresponds to a searched agent action or a searched sequence of agent actions within the search space.

The sampling phase may comprise sampling a current agent action from a set of possible current agent actions based on a probabilistic current action distribution determined for the agent.

The first and/or second search process may be based on the sampled current agent action.

The probabilistic goal distribution may be determined using the observed trajectory and the sampled current agent action.

The probabilistic goal distribution may comprise a conditional probability of each goal given the observed trajectory and the sampled current agent maneuver.

The current action distribution may be determined by a probabilistic maneuver detector based on one or more observations of the agent, such as one or more states of the observed trajectory.

The simulation phase may comprise determining a predicted state of the mobile robot after the selected ego action has been completed.

Multiple iterations of the simulation phase may be performed based on the sampled agent trajectory, with an initial iteration being performed based on the current mobile robot state and each subsequent iteration performed based on the sampled agent trajectory, a further selected ego action and the predicted mobile robot state determined in the previous iteration, until a terminating condition is satisfied, whereby a time sequence of multiple selected ego actions is assessed over the multiple iterations.

The trajectory sampling phase and the multiple iterations of the simulation phase may constitute a single rollout, and the method may comprise performing multiple rollouts, wherein, in each rollout, the sampling phase is repeated to sample an agent goal and a corresponding agent trajectory for use in one or more iterations of the simulation phase performed in that rollout.

A current agent action may be sampled in each rollout for use in that rollout.

The multiple rollouts may be performed according to a probabilistic tree search algorithm, in which a root node of a search tree represents the current state of the mobile robot, edges of the tree represent selected ego actions, and additional nodes represent predicted states, wherein a branch of the tree may be explored in each rollout via the successive selection of ego action(s) in the one or more the iterations of the simulation phase performed in that rollout.

The ego action may be selected probabilistically in each iteration of the simulation phase.

Each action may be a basic maneuver or a macro action formed of a sequence of multiple basic maneuvers.

The method may be implemented in a planner, in order to plan a substantially optimal ego action or series of actions for the mobile robot.

The substantially optimal ego action or series of ego actions may be determined based on rewards backpropagated through the above search tree, each reward computed for a node at which a collision is determined to occur, at which an ego goal is determined to be reached without collision, or at which a branch terminates without collision and without reaching the ego goal.

For each node at which the goal is determined to be reached without collision, the reward may be a reward of a simulated ego trajectory computed for the branch containing that node.

The reward of the simulated ego trajectory may be computed using the same reward function as used for computing the probabilistic goal distribution for the agent and the probabilistic trajectory distribution of the set of possible trajectories associated therewith.

The observed agent trajectory may be derived from physical sensor measurements, or it may be a simulated agent trajectory generated in an offboard simulator.

The possible trajectories may be smoothed trajectories, to which velocity and/or other motion smoothing has been applied.

Velocity and/or other motion smoothing may be applied to the first and second trajectories but may not be applied to the observed trajectory.

Further aspects herein may provide a computer system comprising one or more computers programmed or otherwise configured to implement the method of the first aspect or any embodiment thereof and a computer program configured to program a computer system so as to carry out any such method. The computer system may be implemented in a mobile robot, or an offboard simulator (for example).

Annex A—Evaluations

We evaluate our system in simulations of four urban driving scenarios with diverse scenario initialisations. We show that:
Our method correctly recognises the goals of other vehicles
Goal recognition leads to improved driving behaviour
We can extract intuitive explanations for the recognised goals and predictions, to justify the system's decisions

Videos showing the prediction and planning steps of our system in each scenario can be found in supplementary material.

A. Scenarios

We use the following scenarios:

S1 T-junction (FIG. 5): Ego vehicle approaches T-junction from west, its goal is to reach east end (blue goal). Vehicle V₁ is on same road as ego on adjacent lane, its goal is to exit the road and drive south (purple goal) for which it changes to ego lane in front of ego. Vehicle V₂ approaches the T-junction from south, its goal is to drive east (blue goal), V₂ has to give way at the junction.

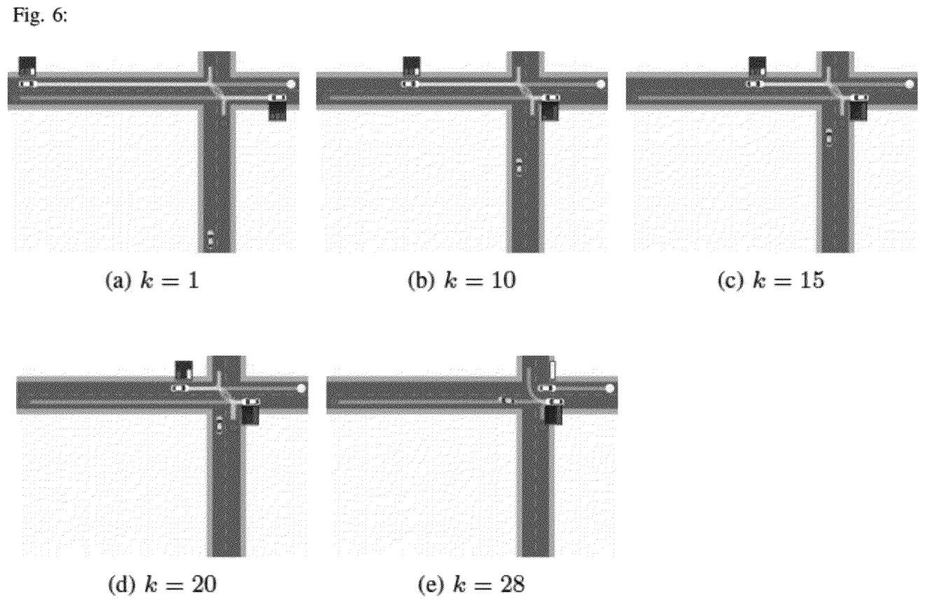

S2 X-junction (FIG. 6): Ego vehicle approaches X-junction from south, its goal is to reach west end (blue goal). Vehicle V₁ approaches X-junction from west end, its goal is to reach the east end (yellow goal). Vehicle V₂ is approaches X-junction from east end, its goal is to reach north end (purple goal), V₂ has to wait for V₁ to pass.

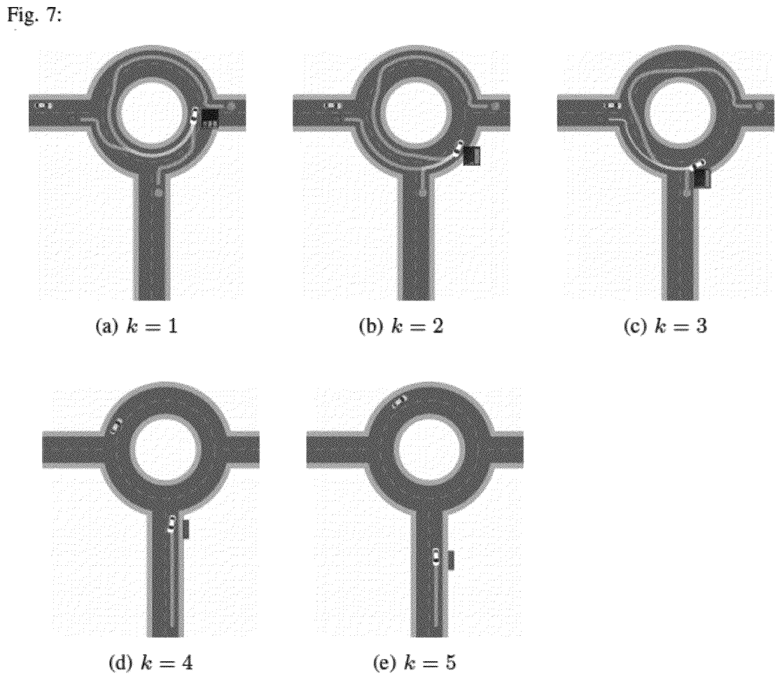

S3 Roundabout (FIG. 7): Ego vehicle approaches roundabout from west, its goal is to drive east (green goal). Vehicle V₁ is inside roundabout, its goal is to exit south (orange goal).

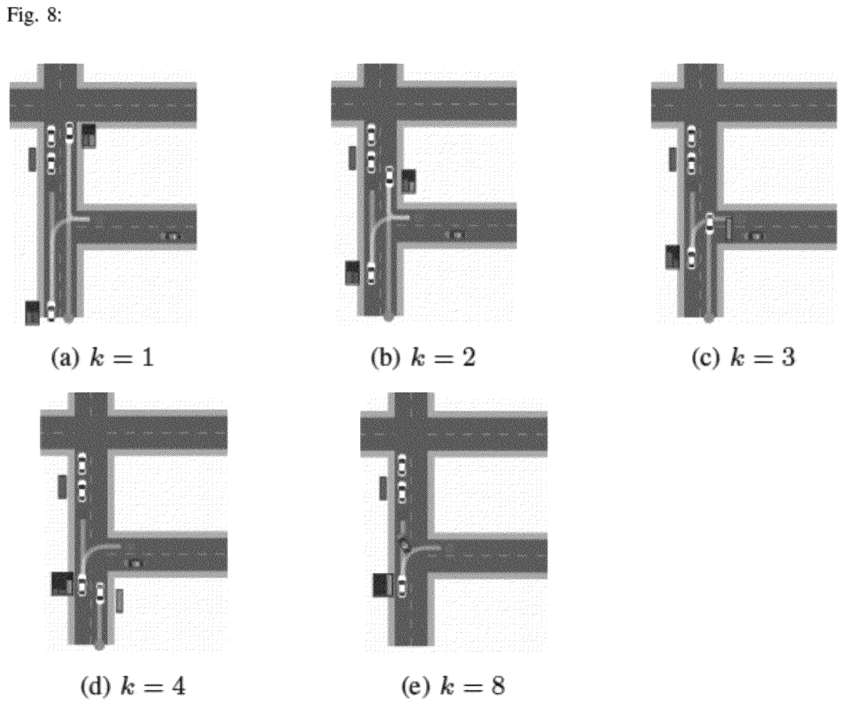

S4 merge (FIG. 8): Ego vehicle approaches main road from east, its goal is to reach north end (purple goal). Several other vehicles are on main road, queuing behind a red light. Vehicle V₁ leaves a gap for ego vehicle to merge in. Vehicle V₂ is driving south (green goal). For each scenario, we generate 100 instances with randomly offset initial longitudinal positions (offset ˜[−10, +10] metres) and initial speed sampled from range [5, 10] m/s for each vehicle including ego vehicle.

B. Baselines & Parameters

We compare the following versions of our system. Full: Full system using goal recognition and MCTS. MAP: Like Full, but MCTS uses only the most probable goal and trajectory for each vehicle. CVel: MCTS without goal recognition, replaced by constant-velocity lane-following prediction. Cons: Like CVel, but using a conservative give-way maneuver which waits until all oncoming vehicles on priority lanes have passed. All of these baselines use closed-loop simulation in MCTS. We also evaluate the Full baseline with closed-loop (Full-CL) and open-loop (Full-OL) simulation.

Maneuvers, macro actions, and goal generation heuristic are as defined earlier in paper. For each other vehicle and generated goal, we generate up to 3 predicted trajectories. We simulate noisy detection of current maneuvers for each other vehicle by giving 0.95 probability to correct current maneuver and the rest uniformly to other maneuvers. MCTS is run at a frequency of 1 Hz, performs D=30 simulations, with a maximum search depth of d=5. Rewards for collision and maximum search depth are set to r_{coll}=rₜₑᵣₘ=−1. Prior probabilities for achievable goals are uniform.

C. Results

FIGS. 5-8 show snapshots for scenario instances at different planning stages of our Full system. The bar plots give the goal probabilities for each other vehicle associated with their most probable current maneuver. For each goal, we show the most probable trajectory prediction from vehicle to goal, with thickness proportional to its probability. We extract intuitive explanations for the goal recognition and maneuver predictions in each scenario, which are given in the figure captions.

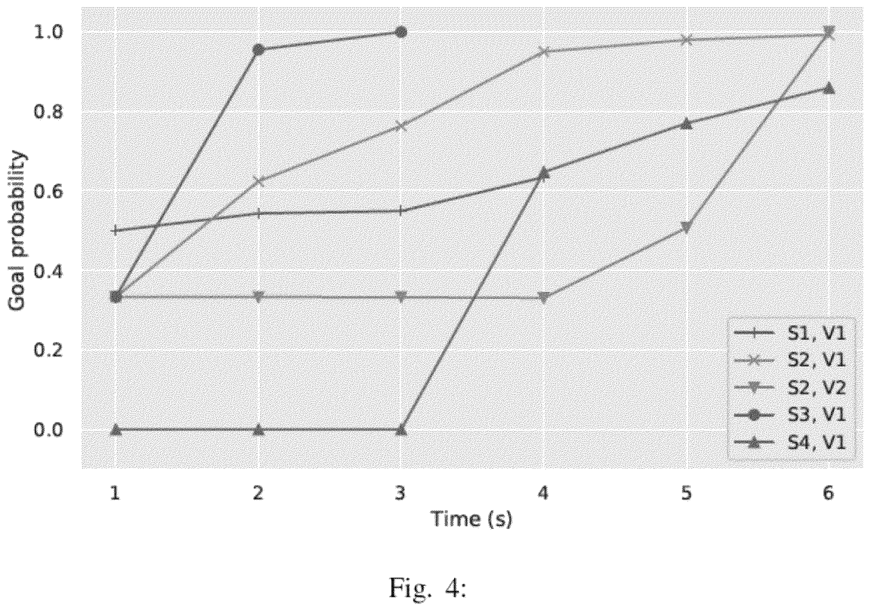

FIG. 4 shows the evolution of probability assigned to correct goal over time, in four scenario instances. As can be seen, the probability approaches the correct goal as other goals are being ruled out by means of rationality principles. We observed this behaviour in all scenario instances.

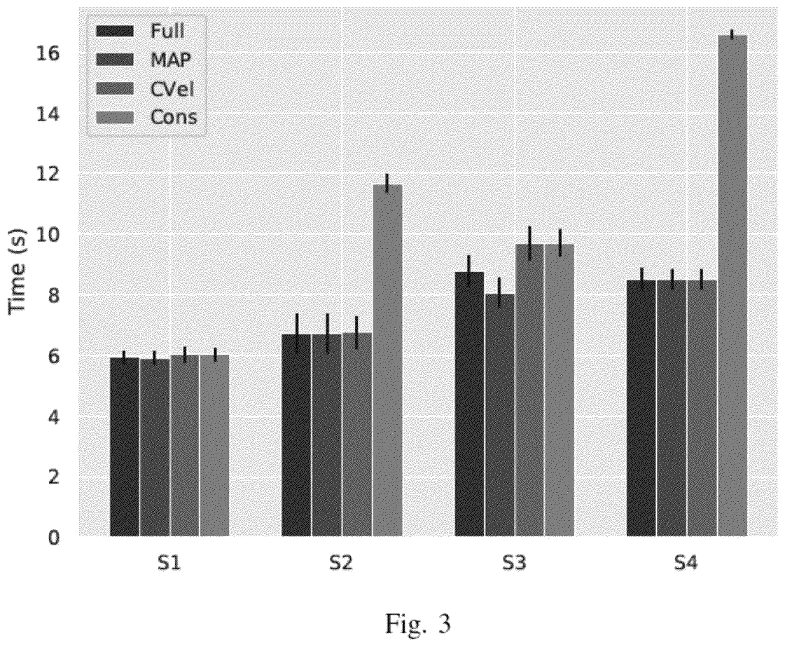

FIG. 3 shows the average times (in seconds) and standard deviations required by each baseline to complete a scenario instance. (S1). All baselines switch lanes in response to V₁ switching lanes. Full and MAP anticipate V₁'s slowdown earlier than other baselines due to inverse planning, allowing them to switch lanes slightly earlier. CVel and Cons only switch lanes once V₁ already started to slow down, and are unable to explain V₁'s behaviour. (S2) Cons requires substantially more time to complete the scenario since it waits for V₂ to clear the lane, which in turn must wait for V₁ to pass. Full and MAP anticipate this behaviour, allowing them to safely enter the road earlier. CVel produces the same result due to zero-velocity of V₂ but cannot fully justify (explain) its decision since it is unable to explain V₂'s waiting behaviour. (S3) Both CVel and Cons require more time to complete the scenario. Here, the constant-velocity prediction in CVel, and waiting for actual clearance as in Cons, amount to approximately equal time of entry for ego vehicle. Full and MAP are able to enter earlier as they recognise V₁'s goal, which is to exit the roundabout. MAP enters earlier than Full since it fully commits to the most probable goal for V₁, while Full exhibits more cautious behaviour due to residual uncertainty about V₁'s goal which could hypothetically lead to crashes. (S4) Cons must wait until V₁ decides to close the gap, after which the ego can enter the road, hence requiring more time. Full and MAP recognise V₁'s goal and can enter safely. CVel again produces the same behaviour based on constant velocity of V₁, but cannot explain the waiting behaviour of V₁.

Full-CL and Full-OL achieved the same completeness rate of scenario instances (100%) and required the same amount of driving time. We found that OL was sufficient, in our specific

FIG. 7: S3: With vehicle V₁ inside the roundabout, (a) Initially we attribute a uniform distribution to all goals for V₁. (b) As Vᵢ changes from the inside to the outside lane of the roundabout and decreases its speed, it significantly biases the ego prediction towards the belief that V₁ will leave in the next exit since that is the rational course of action for that goal, (c) The ego's belief that V₁ will leave increases further as V₁ approaches the exit and continues to slow down, encouraging the ego to enter the roundabout while V₁ is still in roundabout. (d)/(e) V₁ takes the exit at which point the ego has already entered the roundabout.

FIG. 8: S4: With two vehicles stopped at the junction at a traffic light vehicle Vᵢ approaching them from behind, and vehicle V₂ crossing in the opposite direction, (a) Initially we attribute a uniform distribution to all goals for V₁ and V₂. (b) Goal probabilities for both vehicles remain near-uniform due to very minor changes in speeds, (c) V₁ has begun to decelerate at a point where it is more indicative of exiting the road, since the north goal would not require slowing down quite as early according to reward function. Hence ego waits. (d) V‘₁’s zero velocity reveals a stopping goal in its current position, shifting the distribution towards it since stopping is not rational for north/east goals. The interpretation is that V₁ wants the ego to merge in. (e) Given the recognised goal, the ego merges onto the road in front of V₁.

### REFERENCES

Reference is made above to the following, each of which is incorporated herein by reference in its entirety:
[3] P. Auer, N. Cesa-Bianchi, and P. Fischer. Finite-time analysis of the multiarmed bandit problem. Machine Learning, 47(2-3):235-256, 2002.
[6] C. Browne, E. Powley, D. Whitehouse, S. Lucas, P. Cowl-ing, P. Rohlfshagen, S. Tavener, D. Perez, S. Samothrakis, and S. Colton. A survey of Monte Carlo tree search methods. IEEE Transactions on Computational Intelligence and AI in Games, 4(1):1-43, 2012.
[9] E. Galceran, A. Cunningham, R. Eustice, and E. Olson. Multipolicy decision-making for autonomous driving via changepoint-based behavior prediction: Theory and experiment. Autonomous Robots, 41(6):1367-1382, 2017.
[10] C. G'amez Serna and Y. Ruichek. Dynamic speed adap-tation for path tracking based on curvature information and speed limits. Sensors, 17(1383), 2017.
[12] P. Hart, N. Nilsson, and B. Raphael. A formal basis for the heuristic determination of minimum cost paths. In IEEE Transactions on Systems Science and Cybernetics, volume 4, pages 100-107, July 1968.
[16] L. Kocsis and C. Szepesv'ari. Bandit based Monte-Carlo planning. In Proceedings of the 17th European Conference on Machine Learning, pages 282-293. Springer, 2006.
[19] S. Niekum, S. Osentoski, C. Atkeson, and A. Barto. Online Bayesian changepoint detection for articulated motion models. In IEEE International Conference on Robotics and Automation. IEEE, 2015.
[23] A. Somani, N. Ye, D. Hsu, and W. S. Lee. DESPOT: online POMDP planning with regularization. In Advances in Neural Information Processing Systems, pages 1772-1780, 2013.
[25] R. Sutton and A. Barto. Reinforcement Learning: An Introduction. MIT Press, 2018.
[27] A. W″achter and L. Biegler. On the implementation of an interior-point filter line-search algorithm for large-scale nonlinear programming. Mathematical Programming, 106 (1):25-57, 2006.

1. A computer-implemented method of autonomously planning ego actions for a mobile robot in the presence of at least one agent, the method comprising:
receiving an observed trajectory of the agent;
in a sampling phase:
sampling a goal for the agent from a set of available goals based on a probabilistic goal distribution, the observed trajectory used to determine the probabilistic goal distribution, and
sampling an agent trajectory, from a set of possible trajectories associated with the sampled goal, based on a probabilistic trajectory distribution, each trajectory of the set of possible trajectories reaching a location of the associated goal; and
in a simulation phase:
selecting for the mobile robot an ego action from a set of available ego actions, and
based on the selected ego action, the sampled agent trajectory, and a current state of the mobile robot, simulating (i) behaviour of the mobile robot, and (ii) simultaneous behaviour of the agent, in order to assess the viability of the selected ego action given the current mobile robot state.

2. The method of claim 1, comprising:
in a goal recognition phase:
computing the goal distribution by determining, for each goal, a reward difference between (a) a first substantially optimal trajectory from an initial state of the observed trajectory to the location of the goal, and (b) a best-available trajectory that combines (b.i) the observed trajectory from the initial state to a current state of the observed trajectory with (b.ii) a second substantially optimal trajectory from the current state to the location of the goal, wherein the probabilistic trajectory distribution is determined by determining a reward of each trajectory of the set of possible trajectories.

3. The method of claim 2, wherein the probabilistic trajectory distribution comprises a probability of each available goal given the observed trajectory, computed as a product of a prior probability of the goal with a likelihood of the observed trajectory given the goal, the likelihood based on an exponential of the reward difference.

4. The method of claim 2, wherein the probabilistic trajectory distribution comprises a probability of each of the possible trajectories, based on an exponential of the reward of that trajectory.

5. The method of claim 4, wherein the reward of each trajectory and the reward difference of each goal is determined using a reward function that rewards reduced travel time whilst penalizing unsafe trajectories.

6. (canceled)

7. The method of claim 1, wherein the sampled agent trajectory is open loop, but the simulation phase is closed loop with a simulated closed loop agent trajectory being determined based on the sampled open loop agent trajectory, the simulated closed loop trajectory deviating from the sampled open loop trajectory in a manner reactive to the simulated behaviour of the mobile robot.

8.-10. (canceled)

11. The method of claim 1, wherein each trajectory takes the form of a sequence of states, each state encoding spatial information and motion information at a particular time instant.

12. The method of claim 11, wherein the motion component is used as a target, from which the agent is permitted to deviate in the simulation phase in a reactive manner.

13. The method of claim 2, wherein the first and second trajectories are determined in a first search process, which seeks to optimize a reward or estimated cost of the first and second trajectories.

14. The method of claim 13, wherein an estimated cost is used in the trajectory search process, and the estimated cost considers travel time to the goal location only and ignores at least one other cost factor accounted for in determining the reward difference between the first trajectory and the best-available trajectory.

15.-16. (canceled)

17. The method of claim 1, wherein the sampling phase comprises sampling a current agent action from a set of possible current agent actions based on a probabilistic current action distribution determined for the agent.

18.-21. (canceled)

22. The method of claim 1, wherein the simulation phase comprises determining a predicted state of the mobile robot after the selected ego action has been completed.

23. The method of claim 22, wherein multiple iterations of the simulation phase are performed based on the sampled agent trajectory, with an initial iteration being performed based on the current mobile robot state and each subsequent iteration performed based on the sampled agent trajectory, a further selected ego action and the predicted mobile robot state determined in the previous iteration, until a terminating condition is satisfied, whereby a time sequence of multiple selected ego actions is assessed over the multiple iterations.

24. The method of claim 23, wherein the trajectory sampling phase and the multiple iterations of the simulation phase constitute a single rollout, and the method comprises performing multiple rollouts, wherein, in each rollout, the sampling phase is repeated to sample an agent goal and a corresponding agent trajectory for use in one or more iterations of the simulation phase performed in that rollout.

25. (canceled)

26. The method of claim 24, wherein the multiple rollouts are performed according to a probabilistic tree search algorithm, in which a root node of a search tree represents the current state of the mobile robot, edges of the tree represent selected ego actions, and additional nodes represent predicted states, wherein a branch of the tree is explored in each rollout via the successive selection of ego action(s) in the one or more the iterations of the simulation phase performed in that rollout.

27.-28. (canceled)

29. The method of claim 1, implemented in a planner, in order to plan a substantially optimal ego action or series of actions for the mobile robot.

30. The method of claim 26, implemented in a planner, in order to plan a substantially optimal ego action or series of actions for the mobile robot, wherein the substantially optimal ego action or series of ego actions is determined based on rewards backpropagated through the search tree, each reward computed for a node at which a collision is determined to occur, at which an ego goal is determined to be reached without collision, or at which a branch terminates without collision and without reaching the ego goal.

31.-35. (canceled)

36. A computer system comprising an input configured to receive an observed trajectory of an agent, and one or more hardware processors programmed or otherwise configured to implement:
in a sampling phase:
sampling a goal for the agent from a set of available goals based on a probabilistic goal distribution, the observed trajectory used to determine the probabilistic goal distribution, and
sampling an agent trajectory, from a set of possible trajectories associated with the sampled goal, based on a probabilistic trajectory distribution, each trajectory of the set of possible trajectories reaching a location of the associated goal; and
in a simulation phase:
selecting for the mobile robot an ego action from a set of available ego actions, and
based on the selected ego action, the sampled agent trajectory, and a current state of the mobile robot, simulating (i) behaviour of the mobile robot, and (ii) simultaneous behaviour of the agent, in order to assess the viability of the selected ego action given the current mobile robot state.

37. The computer system of claim 36, implemented in a mobile robot, or an offboard simulator.

38. A computer program comprising computer-readable instructions stored on a non-transitory computer-readable storage medium and configured to program a computer system so as to:
receive an observed trajectory of the agent;
in a sampling phase:
sample a goal for the agent from a set of available goals based on a probabilistic goal distribution, the observed trajectory used to determine the probabilistic goal distribution, and
sample an agent trajectory, from a set of possible trajectories associated with the sampled goal, based on a probabilistic trajectory distribution, each trajectory of the set of possible trajectories reaching a location of the associated goal; and
in a simulation phase:
select for the mobile robot an ego action from a set of available ego actions, and
based on the selected ego action, the sampled agent trajectory, and a current state of the mobile robot, simulating (i) behaviour of the mobile robot, and (ii) simultaneous behaviour of the agent, in order to assess the viability of the selected ego action given the current mobile robot state.
